(19) United States
(12) Patent Application Publication
(10) Pub. No.: US 2026/0255273 A1
(43) Pub. Date: Aug. 27, 2026

(54) FAST WAKEUP AND DATA TRANSMISSION METHODS WITH PROGRESSIVE SELF-LINK ADAPTATION FOR WIRELESS COMMUNICATIONS, AND APPARATUSES, SYSTEMS, AND NON-TRANSITORY COMPUTER-READABLE STORAGE DEVICES EMPLOYING SAME

(71) Applicant: Huawei Technologies Co., Ltd., Shenzhen (CN)

(72) Inventors: Huazi Zhang, Zhejiang (CN); Xiaoyan Bi, Ottawa (CA); Hao Tang, Ottawa (CA); Jianglei Ma, Ottawa (CA); Peiying Zhu, Ottawa (CA); Wen Tong, Ottawa (CA)

(21) Appl. No.: 19/643,387

(22) Filed: Apr. 9, 2026

Related U.S. Application Data
(63) Continuation of application No. PCT/CN2024/073067, filed on Jan. 18, 2024.
(60) Provisional application No. 63/543,403, filed on Oct. 10, 2023.

(51) Int. Cl. H04W 52/02; H04L 1/00; H04L 1/1812

(52) U.S. Cl. CPC H04W 52/0235; H04L 1/0042; H04L 1/1819

(57) ABSTRACT

A first communication node side is in wireless communication with a second communication node, at least one of the first and second communication nodes being in reduced power consumption for wireless communication related activities, the method includes: transmitting to the second communication node at least a first redundancy version of a data piece; the data piece is at least one selected from the group of: at least a first portion of a wakeup signal and a first data set, the at least first portion of the wakeup signal comprising control information for the first data set; the first redundancy version is one of a plurality of first candidate redundancy versions; and each of the first candidate redundancy versions comprises a different subset of a plurality of first encoded bits, and the plurality of first encoded bits are obtained by encoding the data piece using a first coding method.

### CROSS-REFERENCE TO RELATED APPLICATIONS

This application is a continuation of International Application No. PCT/CN2024/073067, filed on Jan. 18, 2024, which claims priority of U.S. Provisional Patent Application Ser. No. 63/543,403, filed Oct. 10, 2023, the contents of which are incorporated herein by reference in its entirety.

### TECHNICAL FIELD

The present disclosure relates generally to communication systems, apparatuses, methods, and non-transitory computer-readable storage devices, and in particular to fast wakeup and data transmission methods with progressive self-link adaptation for wireless communications, and wireless-communication apparatuses, systems, and non-transitory computer-readable storage devices employing same.

### BACKGROUND

Wireless communication systems such as mobile communication systems are known. In wireless communication systems, power consumption is generally an important concern especially to user equipments (UEs).

Power saving will be a basic design requirement for 6G. Both UE power saving and network power saving have been discussed in the fifth generation (5G) new radio (NR) standard. In particular, there are different power consumption modes with different power consumption levels, such as deep sleeping, light sleeping, micro-sleeping.

In 6G, power saving will continue to become a key feature. However, due to the more diverse types of devices and applications, and the more densely populated network, effective designs for power saving will be more challenging than previous standards.

On the other hand, link adaptation has been an effective tool to deliver varying-rate communication in different channel conditions. This is crucial for devices operating in fading channels or high mobility. In 5G NR and prior standards, modulation and coding scheme (MCS) is carefully chosen to allow the communication to adapt to varying channel conditions.

### SUMMARY

Embodiments of this disclosure relate to communication systems, apparatuses, methods, and non-transitory computer-readable storage devices employing a fast wakeup and data transmission method for wireless communications.

According to one aspect of this disclosure, there is provided a first method applied in a first communication-node side for wireless communication with a second communication node, at least one of the first and second communication nodes being in reduced power consumption for wireless communication related activities, the first method comprising: transmitting to the second communication node at least a first redundancy version of a data piece; the data piece is at least one selected from the group of: at least a first portion of a wakeup signal and a first data set, the at least first portion of the wakeup signal comprising control information for the first data set; the first redundancy version is one of a plurality of first candidate redundancy versions; and each of the first candidate redundancy versions comprises a different subset of a plurality of first encoded bits, and the plurality of first encoded bits is obtained by encoding the data piece using a first coding method.

In some embodiments, the at least one of the first and second communication nodes is in a sleep state during the transmission of the wakeup signal and the transmission of the first data set.

In some embodiments, the first coding method is a first rateless coding method.

In some embodiments, the wakeup signal comprises the first portion and a second portion; and the first method further comprises: transmitting to the second communication node the second portion of the wakeup signal.

In some embodiments, the second portion of the wakeup signal comprises a chirp signal.

In some embodiments, the plurality of first candidate redundancy versions comprise at least a pair of consecutive first candidate redundancy versions; and a starting bit of a first one of the pair of consecutive first candidate redundancy versions is an immediately next bit of an end bit of a second one of the pair of consecutive first candidate redundancy versions.

In some embodiments, each of the first candidate redundancy versions has a variable length determined based on available time and frequency resource.

In some embodiments, the first method further comprises: receiving a negative-acknowledgement; and transmitting a second redundancy version.

In some embodiments, the first and second redundancy versions are self-decodable.

In some embodiments, the second redundancy version is one of the first candidate redundancy versions different to the first redundancy version.

In some embodiments, the plurality of first encoded bits is obtained by encoding the at least first portion of the wakeup signal using the first coding method.

In some embodiments, the at least first portion of the wakeup signal has a length shorter than a first length-threshold; and the at least first portion of the wakeup signal is represented by one of Manchester codes or on-off keying.

In some embodiments, the first length-threshold is 10 bits.

In some embodiments, the at least first portion of the wakeup signal has a length longer than the first length-threshold and shorter than a second length-threshold; and the first coding method is a coding method using polar codes.

In some embodiments, the second length-threshold is 1000 bits.

In some embodiments, the at least first portion of the wakeup signal has a length longer than the second length-threshold; and wherein the first coding method is a coding method using low-density parity check codes.

In some embodiments, the first coding method is a coding method using one of low-density parity check codes or polar codes.

In some embodiments, the first coding method is the coding method using the low-density parity check codes; and the first redundancy version comprises one or more systematic bits.

In some embodiments, the first redundancy version further comprises one or more pilot symbols for obtaining updated channel measurements; and a modulation-and-coding-scheme for transmitting the second redundancy version is obtained based on the updated channel measurements.

In some embodiments, the modulation-and-coding-scheme for transmitting the second redundancy version is obtained based on soft acknowledgement/negative-acknowledgement information for the transmission of the first redundancy version.

In some embodiments, the first method further comprises: transmitting to the second communication node a third redundancy version of the first data set; the third redundancy version is one of a plurality of second candidate redundancy versions; and each of the second candidate redundancy versions comprises a different subset of a plurality of second encoded bits, and the plurality of second encoded bits are obtained by encoding the first data set using a second coding method.

In some embodiments, the second coding method is a second rateless coding method.

In some embodiments, said transmitting to the second communication node the at least first redundancy version comprises: transmitting to the second communication node a plurality of the first candidate redundancy versions of the data piece.

In some embodiments, the data piece comprises a plurality of code blocks; and the at least first redundancy version comprises a plurality of groups of first redundancy versions, and each group of first redundancy versions correspond to one of the plurality of code blocks.

In some embodiments, the second redundancy version is a redundancy version of a combination of the code blocks corresponding to the plurality of groups of first redundancy versions.

In some embodiments, said transmitting to the second communication node the at least first redundancy version comprises: transmitting to the second communication node the first redundancy version using a modulation order and a code rate; the modulation order and the code rate for transmitting the first redundancy version is selected from a modulation-and-coding-scheme table; the modulation-and-coding-scheme table comprises a plurality of modulation orders and a plurality of code rates arranged in a plurality of records; and each record comprises one of the plurality of modulation orders and one of the plurality of code rates.

In some embodiments, a maximum modulation order of the plurality of modulation orders is 4; and for the records having the same modulation order, a minimum channel coding rate of the records is higher than a minimum channel coding rate corresponding to a same modulation order in connected-state modulation-and-coding-scheme tables used in a connected state.

In some embodiments, the modulation-and-coding-scheme table comprises following columns:

| Modulation-and- | Modulation | Code Rate × |
|---|---|---|
| coding-scheme Index | Order | [1024] |
| I_{MCS} | Qₘ | R |
| 0 | 2 | 340 |
| 1 | 2 | 378 |
| 2 | 2 | 434 |
| 3 | 2 | 490 |
| 4 | 2 | 553 |
| 5 | 2 | 616 |
| 6 | 2 | 658 |
| 7 | 2 | 438 |
| 8 | 2 | 466 |
| 9 | 2 | 517 |
| 10 | 4 | 567 |
| 11 | 4 | 616 |
| 12 | 4 | 666 |
| 13 | 4 | 719 |
| 14 | 4 | 772 |
| 15 | 4 | 822 |

In some embodiments, the code rate for transmitting the first redundancy version is selected using a modulation-and-coding-scheme index from a connected-state modulation-and-coding-scheme table used in a connected state; and the modulation order for transmitting the first redundancy version is a modulation order in the connected-state modulation-and-coding-scheme table corresponding to the selected code rate if the modulation order corresponding to the selected code rate is smaller than an upper bound, or is the upper bound if the modulation order corresponding to the selected code rate is greater than the upper bound.

According to one aspect of this disclosure, there is provided one or more circuits for performing the above-described first method.

According to one aspect of this disclosure, there is provided an apparatus comprising: one or more processors functionally connected to one or more memories for performing the above-described first method.

According to one aspect of this disclosure, there is provided a non-transitory computer readable storage medium comprising a program, wherein the program, when executed by one or more processors, causes the one or more processors to perform the above-described first method.

According to one aspect of this disclosure, there is provided a second method applied in a first communication node side for wireless communication with a second communication node, at least one of the first and second communication nodes being in reduced power consumption for wireless communication related activities, the second method comprising: receiving from the second communication node at least a first redundancy version of a data piece; the data piece is at least one selected from the group of: a first portion of a wakeup signal and a first data set, the at least first portion of the wakeup signal comprising control information for the first data set; the first redundancy version is one of a plurality of first candidate redundancy versions; and each of the first candidate redundancy versions comprises a different subset of a plurality of first encoded bits, and the plurality of first encoded bits is obtained by encoding the data piece using a first coding method.

In some embodiments, the first coding method is a first rateless coding method.

In some embodiments, the wakeup signal comprises the first portion and a second portion; and the second method further comprises: receiving from the second communication node the second portion of the wakeup signal.

In some embodiments, the second portion of the wakeup signal comprises a chirp signal.

In some embodiments, the plurality of first candidate redundancy versions comprise at least a pair of consecutive first candidate redundancy versions; and a starting bit of a first one of the pair of consecutive first candidate redundancy versions is an immediately next bit of an end bit of a second one of the pair of consecutive first candidate redundancy versions.

In some embodiments, each of the first candidate redundancy versions has a variable length determined based on available time and frequency resource.

In some embodiments, the second method further comprises: transmitting a negative-acknowledgement, and receiving a second redundancy version.

In some embodiments, the first and second redundancy versions are self-decodable.

In some embodiments, the second redundancy version is one of the first candidate redundancy versions different to the first redundancy version.

In some embodiments, the plurality of first encoded bits is obtained by encoding the at least first portion of the wakeup signal using the first coding method.

In some embodiments, the at least first portion of the wakeup signal has a length shorter than a first length-threshold; and the at least first portion of the wakeup signal is represented by one of Manchester codes or on-off keying.

In some embodiments, the first length-threshold is 10 bits.

In some embodiments, the at least first portion of the wakeup signal has a length longer than the first length-threshold and shorter than a second length-threshold; and the first coding method is a coding method using polar codes.

In some embodiments, the second length-threshold is 1000 bits.

In some embodiments, the at least first portion of the wakeup signal has a length longer than the second length-threshold; and the first coding method is a coding method using low-density parity check codes.

In some embodiments, the first coding method is a coding method using one of low-density parity check codes or polar codes.

In some embodiments, the first coding method is the coding method using the low-density parity check codes; and the first redundancy version comprises one or more systematic bits.

In some embodiments, the first redundancy version further comprises one or more pilot symbols for obtaining updated channel measurements; and a modulation-and-coding-scheme for transmitting the second redundancy version is obtained based on the updated channel measurements.

In some embodiments, the modulation-and-coding-scheme for transmitting the second redundancy version is obtained based on soft acknowledgement/negative-acknowledgement information for the transmission of the first redundancy version.

In some embodiments, the second method further comprises: receiving from the second communication node a third redundancy version of the first data set; the third redundancy version is one of a plurality of second candidate redundancy versions; and each of the second candidate redundancy versions comprises a different subset of a plurality of second encoded bits, and the plurality of second encoded bits are obtained by encoding the first data set using a second coding method.

In some embodiments, the second coding method is a second rateless coding method.

In some embodiments, said receiving from the second communication node the at least first redundancy version comprises: receiving from the second communication node more than one first redundancy versions of the data piece.

In some embodiments, the data piece comprises a plurality of code blocks; and the at least first redundancy version comprises a plurality of groups of first redundancy versions, and each group of first redundancy versions correspond to one of the plurality of code blocks.

In some embodiments, the second redundancy version is a redundancy version of a combination of the code blocks corresponding to the plurality of groups of first redundancy versions.

In some embodiments, said receiving from the second communication node the at least first redundancy version comprises: receiving from the second communication node the first redundancy version using a modulation order and a code rate that are used for the transmission of the first redundancy version; the modulation order and the code rate for transmitting the first redundancy version is selected from a modulation-and-coding-scheme table; the modulation-and-coding-scheme table comprises a plurality of modulation orders and a plurality of code rates arranged in a plurality of records; and each record comprises one of the plurality of modulation orders and one of the plurality of code rates.

In some embodiments, a maximum modulation order of the plurality of modulation orders is 4; and for the records having the same modulation order, a minimum channel coding rate of the records is higher than a minimum channel coding rate corresponding to a same modulation order in connected-state modulation-and-coding-scheme tables used in a connected state.

In some embodiments, the modulation-and-coding-scheme table comprises following columns:

| Modulation-and- | Modulation | Code Rate × |
|---|---|---|
| coding-scheme Index | Order | [1024] |
| I_{MCS} | Qₘ | R |
| 0 | 2 | 340 |
| 1 | 2 | 378 |
| 2 | 2 | 434 |
| 3 | 2 | 490 |
| 4 | 2 | 553 |
| 5 | 2 | 616 |
| 6 | 2 | 658 |
| 7 | 2 | 438 |
| 8 | 2 | 466 |
| 9 | 2 | 517 |
| 10 | 4 | 567 |
| 11 | 4 | 616 |
| 12 | 4 | 666 |
| 13 | 4 | 719 |
| 14 | 4 | 772 |
| 15 | 4 | 822 |

In some embodiments, the code rate for transmitting the first redundancy version is selected using a modulation-and-coding-scheme index from a connected-state modulation-and-coding-scheme table used in a connected state; and the modulation order for transmitting the first redundancy version is a modulation order in the connected-state modulation-and-coding-scheme table corresponding to the selected code rate if the modulation order corresponding to the selected code rate is smaller than an upper bound, or is the upper bound if the modulation order corresponding to the selected code rate is greater than the upper bound.

According to one aspect of this disclosure, there is provided one or more circuits for performing the above-described second method.

According to one aspect of this disclosure, there is provided an apparatus comprising: one or more processors functionally connected to one or more memories for performing the above-described second method.

According to one aspect of this disclosure, there is provided a non-transitory computer readable storage medium comprising a program, wherein the program, when executed by one or more processors, causes the one or more processors to perform the above-described second method.

According to one aspect of this disclosure, there is provided an apparatus, and configured to perform the any one of above mentioned methods and their embodiments. Specifically, the apparatus includes one or more units configured to perform the any one of above mentioned methods and their embodiments.

According to one aspect of this disclosure, there is provided a computer-readable storage medium. The computer-readable storage medium stores a computer program, and when the computer program is executed by an apparatus, the apparatus is enabled to implement the any one of above mentioned methods and their embodiments.

According to one aspect of this disclosure, there is provided a computer program product including one or more instructions. When the instructions are executed by a computer, the apparatus is enabled to implement the any one of above mentioned methods and their embodiments.

According to one aspect of this disclosure, there is provided a computer program. When the computer program is executed by a computer, an apparatus is enabled to implement the any one of above mentioned methods and their embodiments.

According to one aspect of this disclosure, there is provided a communication system. The communication system includes a first communication-node and/or a second communication-node, the first communication-node is configured to perform the method regarding the first communication-node as stated above, and the second communication-node is configured to perform the method regarding the second communication-node as stated above.

According to one aspect of this disclosure, there is provided an apparatus for implementing the method in any possible implementation of the foregoing aspects.

The fast wakeup and data transmission method with progressive self-link adaptation disclosed herein may provide various advantages such as:
Low energy consumption
   Lengthy wakeup procedures and state transitions in conventional methods are reduced.
Improved spectrum efficiency and lowered latency
   Initial transmission may be fast and may be successfully decoded if one or more initial channel parameters are accurate.
   If the one or more initial channel parameters are inaccurate, the received signals can still be exploited for soft combining with the subsequent received signals.
   The spectrum usage is efficient.

### BRIEF DESCRIPTION OF THE DRAWINGS

For a more complete understanding of this disclosure, reference is made to the following description and accompanying drawings, in which:

FIGS. 1A and 1B are simplified schematic diagrams showing the structure of a communication system, according to some embodiments of this disclosure;

FIG. 2A is a simplified schematic diagram showing a user equipment (UE), a terrestrial transmit-and-receive point (T-TRP), and a non-terrestrial transmit-and-receive points (NT-TRP) of the communication system shown in FIG. 1A;

FIG. 2B is a simplified schematic diagram showing units or modules in a device, such as in UE or in TRP of the communication system shown in FIG. 1A;

FIG. 3 is a simplified schematic diagrams showing the structure of the communication system shown in FIG. 1A for integrated sensing and communication (ISAC) using a plurality of sensing and communication (SAC) nodes, according to some embodiments of this disclosure;

FIG. 4 is a simplified schematic diagram showing a sensing management function (SMF) of the communication system shown in FIG. 1A, implemented as a physically independent entity;

FIG. 5 is a schematic diagram showing the radio resource control (RRC) states of a UE in fifth generation (5G) new radio (NR);

FIG. 6A is a schematic diagram showing the states of a device such as a UE or a TRP, according to some embodiments of this disclosure;

FIG. 6B is a schematic diagram showing the states of a device such as a UE or a TRP, according to some other embodiments of this disclosure;

FIG. 7 is a schematic diagram showing an example of a communication-parameter map and a geographic map related thereto;

FIG. 8 is a flowchart showing the steps of a fast wakeup and downlink (DL) data transmission method, according to some embodiments of this disclosure;

FIG. 9 is a schematic diagram showing the structure of the DL data burst used in the method shown in FIG. 8, according to some embodiments of this disclosure;

FIG. 10 is a schematic diagram showing the structure of the DL data burst used in the method shown in FIG. 8, according to some other embodiments of this disclosure;

FIG. 11 is a flowchart showing the steps of a fast wakeup and data transmission method for waking up a TRP followed with uplink (UL) data transmission, according to some embodiments of this disclosure;

FIG. 12 is a schematic diagram showing the structure of the UL data burst used in the fast wakeup and data transmission method shown in FIG. 11, according to some embodiments of this disclosure;

FIG. 13 is a schematic diagram showing the structure of the UL data burst used in the fast wakeup and data transmission method shown in FIG. 11, according to some other embodiments of this disclosure;

FIG. 14 is a schematic diagram showing the structure of the UL data burst used in the fast wakeup and data transmission method shown in FIG. 11, according to yet some other embodiments of this disclosure;

FIG. 15 is a flowchart showing the steps of a fast wakeup and data transmission method for waking up a TRP and a UE followed with simultaneous UL and DL data transmissions, according to some embodiments of this disclosure;

FIG. 16A is a schematic diagram showing the structure of the UL and DL data bursts used in the fast wakeup and data transmission method shown in FIG. 15, which gives rise to a full-duplex (FD) or subband-FD fast-wakeup and data-transmission, according to some embodiments of this disclosure;

FIG. 16B is a schematic diagram showing the structure of the UL and DL data bursts used in the fast wakeup and data transmission method shown in FIG. 15, according to some other embodiments of this disclosure;

FIG. 17 is a flowchart showing the steps of a fast wakeup and data transmission method generalizing the fast wakeup and data transmission methods shown in FIGS. 8, 11, and 15;

FIG. 18 is a schematic diagram showing an example of conventional redundancy versions (RVs);

FIG. 19A is a schematic diagram showing an example of flexible RVs, according to some embodiments of this disclosure;

FIG. 19B is a schematic diagram showing an alternative interpretation of the flexible RVs shown in FIG. 19A;

FIG. 20 is a schematic diagram showing an example of flexible RVs, according to some embodiments of this disclosure;

FIG. 21 is a schematic diagram showing a portion of a DL data burst using multiple RV transmissions, according to some embodiments of this disclosure;

FIG. 22 is a schematic diagram showing a large-size data-bearing and/or control information bearing field of a data burst is partitioned into a plurality of code blocks (CBs), and each CB is encoded using a rateless coding method for obtaining a plurality of RVs, according to some embodiments of this disclosure;

FIG. 23 is a schematic diagram showing a portion of a DL data burst transmitting a plurality of RVs shown in FIG. 22, according to some embodiments of this disclosure;

FIG. 24 is a flowchart showing the steps of a fast wakeup and data transmission method for selecting the code rate and modulation order from a connected-state MCS table for the first transmission of the data-bearing and control information bearing fields, according to some embodiments of this disclosure; and

FIG. 25 is a schematic diagram showing an example of signal transmission using the fast wakeup and data transmission method shown in FIG. 24.

### DETAILED DESCRIPTION

a. System Structure

### A-1. General System Structure

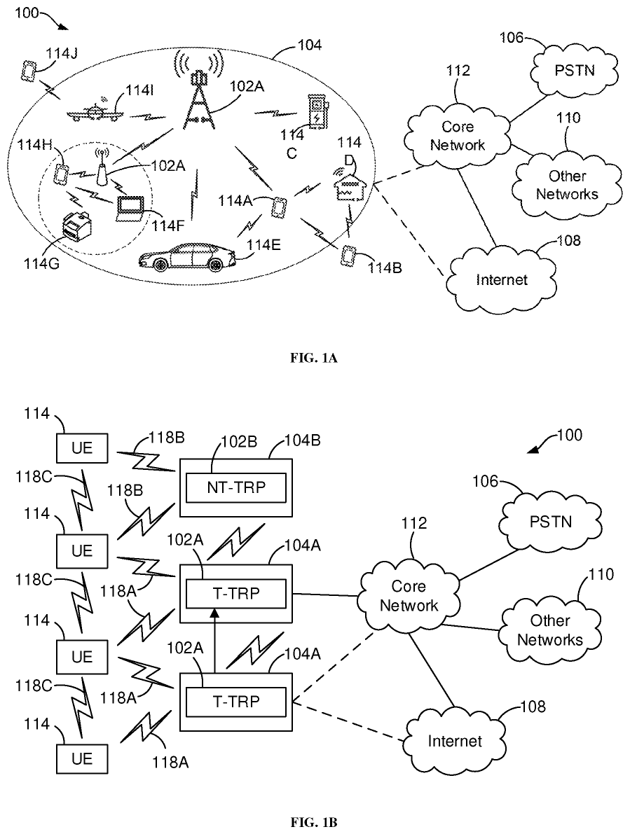

Referring to FIG. 1A, as an illustrative example without limitation, a simplified schematic illustration of a communication system is provided. The communication system 100 comprises a radio access network (RAN) 104. The RAN 104 may be a next generation (for example, sixth generation (6G) or later) RAN, or a legacy (for example, fifth-generation (5G), fourth-generation (4G), third-generation (3G), or second-generation (2G)) RAN. One or more user equipments (UEs) 114A to 114J (generically referred to as 114) may be interconnected to one another or connected to one or more network nodes 102A in the RAN 104. A core network 112 may be a part of the communication system and may be dependent or independent of the radio access technology used in the communication system 100. Also the communication system 100 comprises a public switched telephone network (PSTN) 106, the internet 108, and other networks 110.

FIG. 1B illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, and unicast, and/or the like. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, and/or the like). The communication system 100 may provide a high degree of availability and robustness through a joint operation of the terrestrial communication system and the non-terrestrial communication system. For example, integrating a non-terrestrial communication system (or components thereof) into a terrestrial communication system may result in what may be considered a heterogeneous network comprising multiple layers. As those skilled in the art will appreciate, the heterogeneous network may achieve improved overall performance through efficient multi-link joint operation, more flexible functionality sharing, and faster physical layer link switching between terrestrial networks and non-terrestrial networks.

The terrestrial communication system and the non-terrestrial communication system may be considered sub-systems of the communication system 100. In the example shown, the communication system 100 includes UEs 114, RANs 104A (also called “terrestrial communication networks”), non-terrestrial communication networks 104B, a core network 112, a public switched telephone network (PSTN) 106, the internet 108, and other networks 110. The RANS 104A include respective base stations (BSs) 102A, which may be generically referred to as terrestrial transmit-and-receive points (T-TRPs) 102A. The non-terrestrial communication network 104B includes an access node 102B, which may be generically referred to as a non-terrestrial transmit-and-receive point (NT-TRP) 102B. The T-TRPs 102A and the NT-TRP 102B may be generally referred to as TRPs or access nodes 102.

Any UE 114 may be alternatively or additionally configured to interface, access, or communicate with any other T-TRP 102A and NT-TRP 102B, the internet 108, the core network 112, the PSTN 106, the other networks 110, or any combination of the preceding. In some examples, UE 114 may communicate an uplink (UL) and/or downlink (DL) transmission over a terrestrial interface 118A with T-TRP 102A. In some examples, A UE 114 may communicate a UL and/or DL transmission over a non-terrestrial interface 118B with NT-TRP 102B. In some examples, the UEs 114 may also communicate directly with one another via one or more sidelink air interfaces 118C.

The air interfaces 118A and 118C may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA; also known as discrete Fourier transform spread OFDMA, DFT-s-OFDMA) in the air interfaces 118A and 118C. The air interfaces 118A and 118C may utilize other higher dimension signal spaces, which may involve a combination of orthogonal and/or non-orthogonal dimensions.

The non-terrestrial air interface 118B may enable communication between a UE 114 and one or multiple NT-TRPs 102B via a wireless link or simply a link. For some examples, the link is a dedicated connection for unicast transmission, a connection for broadcast transmission, or a connection between a group of UEs 114 and one or multiple NT-TRPs 102B for multicast transmission.

The RANs 104A are in communication with the core network 112 to provide the UEs 114 with various services such as voice, data, and other services. The RANs 104A and/or the core network 112 may be in direct or indirect communication with one or more other RANs (not shown), which may or may not be directly served by core network 112, and may or may not employ the same radio access technology as RANS 104A. The core network 112 may also serve as a gateway access between (i) the RANs 104A, or UEs 114, or both, and (ii) other networks (such as the PSTN 106, the internet 108, and the other networks 110). In addition, some or all of the UEs 114 may include functionality for communicating with different wireless networks over different wireless links using different wireless technologies and/or protocols. Instead of wireless communication (or in addition thereto), the UEs 114 may communicate via wired communication channels to a service provider or switch (not shown), and to the internet 108. PSTN 106 may include circuit switched telephone networks for providing plain old telephone service (POTS). Internet 108 may include a network of computers and subnets (intranets) or both, and incorporate protocols, such as internet protocol (IP), transmission control protocol (TCP), user datagram protocol (UDP). UEs 114 may be multimode devices capable of operation according to multiple radio access technologies, and incorporate multiple transceivers necessary to support such.

### a-2. Basic Component Structure

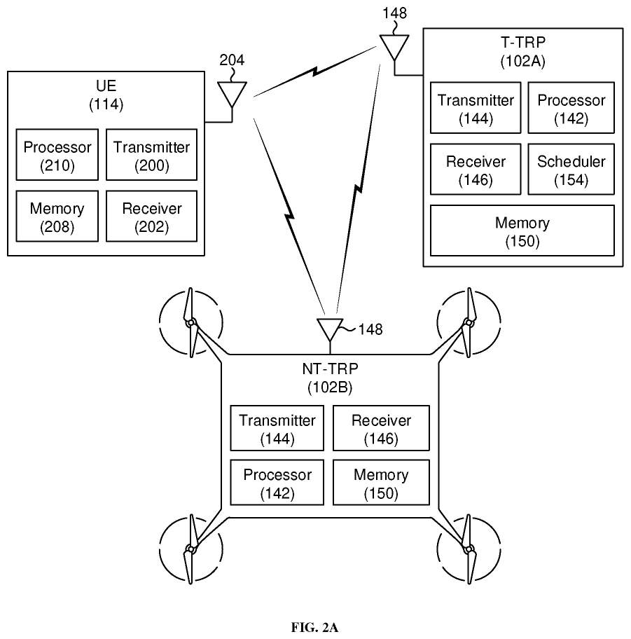

FIG. 2A illustrates an example of a UE 114, a T-TRP 102A, and a NT-TRP 102B. The UE 114 is used to connect persons, objects, machines, and/or the like. The UE 114 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, and/or the like.

Each UE 114 represents any suitable end-user device for wireless operation and may include such devices (or may be referred to) as a user device, a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, a wearable device (such as a watch, a pair of glasses, a head mounted equipment, and/or the like), an industrial device, a robot, or apparatus (for example, communication module, modem, or chip) in or comprising the foregoing devices, among other possibilities. Future generation UEs 114 may be referred to using other terms. Each UE 114 connected to T-TRP 102A and/or NT-TRP 102B may be dynamically or semi-statically turned-on (that is, established, activated, or enabled), turned-off (that is, released, deactivated, or disabled) and/or configured in response to one of more of: connection availability and connection necessity.

The T-TRP 102A may be known by other names in some implementations, such as a base station, a base transceiver station (BTS), a radio base station, a network node, a network device, a device on the network side, a transmit/receive node, a Node B, an evolved NodeB (eNodeB or eNB), a home eNodeB, a next generation NodeB (gNB), a transmission point (TP), a site controller, an access point (AP), or a wireless router, a relay station, a remote radio head, a terrestrial node, a terrestrial network device, or a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 102A may be macro BSs, pico BSs, relay node, donor node, or the like, or combinations thereof. The T-TRP 102A may refer to the foregoing devices or refer to an apparatus (for example, a communication module, a modem, a chip, or the like) in the foregoing devices.

In some embodiments, the parts of the T-TRP 102A may be distributed. For example, some of the modules of the T-TRP 102A may be located remote from the equipment housing the antennas of the T-TRP 102A, and may be coupled to the equipment housing the antennas over a communication link (not shown) sometimes known as front haul, such as common public radio interface (CPRI). Therefore, in some embodiments, the term T-TRP 102A may also refer to modules on the network side that perform processing operations, such as determining the location of the UE 114, resource allocation (scheduling), message generation, and encoding/decoding, and that are not necessarily part of the equipment housing the antennas of the T-TRP 102A. The modules may also be coupled to other T-TRPs. In some embodiments, the T-TRP 102A may actually be a plurality of T-TRPs that are operating together to serve the UE 114, for example, through coordinated multipoint transmissions.

The T-TRP 102A comprises one or more circuits (such as one or more electronic circuits and/or one or more optical circuits) forming various components. For example, the T-TRP 102 may comprise at least one transmitter 144 and at least one receiver 146 coupled to one or more antennas 148. Only one antenna 148 is illustrated. One, some, or all of the antennas may alternatively be panels. The transmitter 144 and the receiver 146 may be integrated as a transceiver. The T-TRP 102A may further comprise at least one processor 142 for performing operations including those related to: preparing a transmission for DL transmission to the UE 114, processing an UL transmission received from the UE 114, preparing a transmission for backhaul transmission to NT-TRP 102B, and processing a transmission received over backhaul from the NT-TRP 102B. Processing operations related to preparing a transmission for DL or backhaul transmission may include operations such as encoding, modulating, precoding (for example, multiple input multiple output (MIMO) precoding), transmit beamforming, and generating symbols for transmission. Processing operations related to processing received transmissions in the UL or over backhaul may include operations such as receive beamforming, and demodulating and decoding received symbols. The processor 142 may also perform operations relating to network access (for example, initial access) and/or DL synchronization, such as generating the content of synchronization signal blocks (SSBs), generating the system information, and/or the like. In some embodiments, the processor 142 also generates the indication of beam direction, for example, BAI, which may be scheduled for transmission by a scheduler 154. The processor 142 performs other network-side processing operations described herein, such as determining the location of the UE 114, determining where to deploy NT-TRP 102B, and/or the like. In some embodiments, the processor 142 may generate signaling, for example, to configure one or more parameters of the UE 114 and/or one or more parameters of the NT-TRP 102B. Any signaling generated by the processor 142 is sent by the transmitter 144. Note that “signaling”, as used herein, may alternatively be called control signaling. Dynamic signaling may be transmitted in a control channel, for example, a physical downlink control channel (PDCCH), and static or semi-static higher layer signaling may be included in a packet transmitted in a data channel, for example, in a physical downlink shared channel (PDSCH), in which case the signaling may be known as higher-layer signaling, static signaling, or semi-static signaling. Higher-layer signaling may also refer to radio resource control (RRC) protocol signaling or media access control-control element (MAC-CE) signaling.

A scheduler 154 may be coupled to the processor 142. The scheduler 154 may be included within or operated separately from the T-TRP 102A, which may schedule UL, DL, and/or backhaul transmissions, including issuing scheduling grants and/or configuring scheduling-free (for example, “configured grant”) resources. The T-TRP 102A may further comprise a memory 150 for storing information and data. The memory 150 stores instructions and data used, generated, or collected by the T-TRP 102A. For example, the memory 150 may store software instructions or modules configured to implement some or all of the functionality and/or embodiments described herein and that are executed by the processor 142.

Although not illustrated, the processor 142 may form part of the transmitter 144 and/or receiver 146. Also, although not illustrated, the processor 142 may implement the scheduler 154. Although not illustrated, the memory 150 may form part of the processor 142.

The processor 142, the scheduler 154, the processing components of the transmitter 144, and the processing components of the receiver 146 may each be implemented by the same or different one or more processors that are configured to execute instructions stored in a memory, for example, in memory 150. Alternatively, some or all of the processor 142, the scheduler 154, the processing components of the transmitter 144, and the processing components of the receiver 146 may be implemented using dedicated circuitry, such as a field-programmable gate array (FPGA), a graphical processing unit (GPU), or an application-specific integrated circuit (ASIC).

Although the NT-TRP 102B is illustrated as a drone only as an example, the NT-TRP 102B may be implemented in any suitable non-terrestrial form, such as satellites and high altitude platforms, including international mobile telecommunication base stations and unmanned aerial vehicles, for example. Also, the NT-TRP 102B may be known by other names in some implementations, such as a non-terrestrial node, a non-terrestrial network device, or a non-terrestrial base station.

The NT-TRP 102B comprises one or more circuits (such as one or more electronic circuits and/or one or more optical circuits) forming various components, and may have a similar structure as the T-TRP 102A. For example, the NT-TRP 102B may comprise a transmitter 144 and a receiver 146 coupled to one or more antennas 148. Only one antenna 148 is illustrated to avoid congestion in the drawing. One, some, or all of the antennas may alternatively be panels. The transmitter 144 and the receiver 146 may be integrated as a transceiver. The NT-TRP 102B further includes at least one processor 142 for performing operations including those related to: preparing a transmission for DL transmission to the UE 114, processing an UL transmission received from the UE 114, preparing a transmission for backhaul transmission to T-TRP 102A, and processing a transmission received over backhaul from the T-TRP 102A. Processing operations related to preparing a transmission for DL or backhaul transmission may include operations such as encoding, modulating, precoding (for example, MIMO precoding), transmit beamforming, and generating symbols for transmission. Processing operations related to processing received transmissions in the UL or over backhaul may include operations such as receive beamforming, and demodulating and decoding received symbols. In some embodiments, the processor 142 implements the transmit beamforming and/or receive beamforming based on beam direction information (for example, BAI) received from T-TRP 102A. In some embodiments, the processor 142 may generate signaling, for example, to configure one or more parameters of the UE 114. In some embodiments, the NT-TRP 102B implements physical layer processing, but does not implement higher layer functions such as functions at the medium access control (MAC) or radio link control (RLC) layer. As this is only an example, more generally, the NT-TRP 102B may implement higher layer functions in addition to physical layer processing.

The NT-TRP 102B further includes a memory 150 for storing information and data. Although not illustrated, the processor 142 may form part of the transmitter 144 and/or receiver 146. Although not illustrated, the memory 150 may form part of the processor 142.

The processor 142, the processing components of the transmitter 144, and the processing components of the receiver 146 may each be implemented by the same or different one or more processors that are configured to execute instructions stored in a memory, for example, in memory 150. Alternatively, some or all of the processor 142, the processing components of the transmitter 144, and the processing components of the receiver 146 may be implemented using dedicated circuitry, such as a programmed FPGA, a hardware accelerator (for example, a GPU or artificial intelligence (AI) accelerator), or an ASIC. In some embodiments, the NT-TRP 102B may actually be a plurality of NT-TRPs that are operating together to serve the UE 114, for example, through coordinated multipoint transmissions.

The T-TRP 102A, the NT-TRP 102B, and/or the UE 114 may include other components, but these have been omitted for the sake of clarity.

The UE 114 comprises one or more circuits (such as one or more electronic circuits and/or one or more optical circuits) forming various components. More specifically, the UE 114 includes a transmitter 200 and a receiver 202 coupled to one or more antennas 204. Only one antenna 204 is illustrated to avoid congestion in the drawing. One, some, or all of the antennas may alternatively be panels. The transmitter 200 and the receiver 202 may be integrated, for example, as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The UE 114 includes at least one memory 208. The memory 208 stores instructions and data used, generated, or collected by the UE 114. For example, the memory 208 may store software instructions or modules configured to implement some or all of the functionality and/or embodiments described herein and that are executed by at least one processing unit (for example, the at least one processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The UE 114 may further include one or more input/output devices (not shown) or interfaces (such as a wired interface to the internet 108 in FIG. 1A). The input/output devices permit interaction with a user or other devices in the network. Each input/output device includes any suitable structure for providing information to or receiving information from a user, and/or for network interface communications. Suitable structures include, for example, a speaker, a microphone, a keypad, a keyboard, a display, a touch screen, a network interface, and/or the like.

The UE 114 further includes at least one processor 210 for performing operations including those operations related to preparing a transmission for UL transmission to the T-TRP 102A and/or NT-TRP 102B, those operations related to processing DL transmissions received from the T-TRP 102A and/or NT-TRP 102B, and those operations related to processing sidelink transmission to and from another UE 114. Processing operations related to preparing a transmission for UL transmission may include operations such as encoding, modulating, transmit beamforming, and generating symbols for transmission. Processing operations related to processing DL transmissions may include operations such as receive beamforming, demodulating and decoding received symbols. Depending upon the embodiment, a DL transmission may be received by the receiver 202, possibly using receive beamforming, and the processor 210 may extract signaling from the DL transmission (for example, by detecting and/or decoding the signaling). An example of signaling may be a reference signal transmitted by the T-TRP 102A and/or NT-TRP 102B. In some embodiments, the processor 142 implements the transmit beamforming and/or the receive beamforming based on the indication of beam direction, for example, beam angle information (BAI), received from T-TRP 102. In some embodiments, the processor 210 may perform operations relating to network access (for example, initial access) and/or DL synchronization, such as operations relating to detecting a synchronization sequence, decoding and obtaining the system information, and/or the like. In some embodiments, the processor 210 may perform channel estimation, for example, using a reference signal received from the T-TRP 102A and/or NT-TRP 102B.

Although not illustrated, the processor 210 may form part of the transmitter 200 and/or part of the receiver 202. Although not illustrated, the memory 208 may form part of the processor 210.

The processor 210, the processing components of the transmitter 200, and the processing components of the receiver 202 may each be implemented by the same or different one or more processors that are configured to execute instructions stored in a memory (for example, in memory 208). Alternatively, some or all of the processor 210, the processing components of the transmitter 200, and the processing components of the receiver 202 may be implemented using dedicated circuitry, such as a programmed FPGA, an ASIC, or a hardware accelerator such as a GPU or an AI accelerator.

### a-3. Basic Module Structure

One or more steps of the embodiment methods provided herein may be performed by corresponding units or modules, according to FIG. 2B. FIG. 2B illustrates units or modules in a device, such as in a UE 114 or in a TRP 102. For example, a signal may be transmitted by a transmitting unit or a transmitting module. A signal may be received by a receiving unit or a receiving module. A signal may be processed by a processing unit or a processing module. Other steps may be performed by an AI or machine learning (ML) module. The respective units or modules may be implemented using hardware, one or more components or devices that execute software, or a combination thereof. For instance, one or more of the units or modules may be an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the UEs 114 and TRP 102 are known to those of skill in the art. As such, these details are omitted here.

### a-4. Intelligent Air Interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (for example, data) over a wireless communications link. The wireless communications link may support a link between a RAN and a UE (for example, a “Uu” link), and/or the wireless communications link may support a link between device and device, such as between two user equipments (for example, a “sidelink”), and/or the wireless communications link may support a link between a non-terrestrial (NT)-communication network and a UE. The followings are some examples for the above components:
A waveform component may specify a shape and form of a signal being transmitted. Waveform options may include orthogonal multiple access waveforms and non-orthogonal multiple access waveforms. Non-limiting examples of such waveform options include orthogonal frequency division multiplexing (OFDM), filtered OFDM (f-OFDM), time windowing OFDM, filter bank multicarrier (FBMC), universal filtered multicarrier (UFMC), generalized frequency division multiplexing (GFDM), wavelet packet modulation (WPM), faster than Nyquist (FTN) waveform, Frequency-Modulated Continuous Wave (FMCW), chip waveforms and low peak to average power ratio waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: TDMA, FDMA, CDMA, SC-FDMA, low density signature multicarrier code division multiple access (LDS-MC-CDMA), non-orthogonal multiple access (NOMA), pattern division multiple access (PDMA), lattice partition multiple access (LPMA), resource spread multiple access (RSMA), and sparse code multiple access (SCMA). Furthermore, multiple access technique options may include: scheduled access vs. non-scheduled access, also known as configured grant access or grant-free access; non-orthogonal multiple access vs. orthogonal multiple access, for example, via a dedicated channel resource (for example, no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include Reed-Muller (RM) codes, turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface may not be changed or adapted once the air interface is defined. In some implementations, only limited parameters or modes of an air interface, such as a cyclic prefix (CP) length or a MIMO mode, may be configured. In some embodiments, an air interface design may provide a unified or flexible framework to support below 6 gigahertz (GHz) and beyond 6 GHz frequency (for example, mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible RAN slicing through channel resource sharing between different services in both frequency and time.

### a-5. Frame Structure

A frame structure is a feature of the wireless communication physical layer that defines a time domain signal transmission structure, for example, to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) including subband full duplex, communication may be possible. FDD communication is when transmissions in different directions (for example, UL vs. DL) occur in different frequency bands. TDD communication is when transmissions in different directions (for example, UL vs. DL) occur over different time durations. FD communication is when transmission and reception occurs on the same time-frequency resource, that is, a device may both transmit and receive on the same frequency resource concurrently in time.

One example of a frame structure is a frame structure in long-term evolution (LTE) having the following specifications: each frame is 10 milliseconds (ms) in duration; each frame has 10 subframes, which are each one (1) ms in duration; each subframe includes two slots, each of which is 0.5 ms in duration; each slot is for transmission of seven (7) OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between UL and DL in TDD has to be the integer time of OFDM symbol duration.

Another example of a frame structure is a frame structure in the fifth generation (5G) new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of one (1) ms each; a slot is defined as 14 OFDM symbols, and slot length depends upon the numerology. For example, the NR frame structure for normal CP 15 kilohertz (kHz) subcarrier spacing (“numerology 1”) and the NR frame structure for normal CP 30 kHz subcarrier spacing (“numerology 2”) are different. For 15 kHz subcarrier spacing a slot length is one (1) ms, and for 30 kHz subcarrier spacing a slot length is 0.5 ms. The NR frame structure may have more flexibility than the LTE frame structure.

Another example of a frame structure is an example flexible frame structure, for example, for use in a 6G network or later. In a flexible frame structure, a symbol block may be defined as the minimum duration of time that may be scheduled in the flexible frame structure. A symbol block may be a unit of transmission having an optional redundancy portion (for example, CP portion) and an information (for example, data) portion. An OFDM symbol is an example of a symbol block. A symbol block may alternatively be called a symbol. Embodiments of flexible frame structures include different parameters that may be configurable, for example, frame length, subframe length, symbol block length, and/or the like. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple DL synchronization channels and/or one or multiple DL broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, for example, for time domain alignment, then the duration of the subframe may be configurable. For example, a subframe may be configured to have a length of 0.1 ms, 0.2 ms, 0.5 ms, one (1) ms, two (2) ms, five (5) ms, or the like. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (for example, in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling may be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, for example, if more flexible symbol durations are implemented using inverse discrete Fourier transform (IDFT) instead of fast Fourier transform (FFT). Additional examples of frame structures may be used with different SCSs.
(5) Flexible transmission duration of basic transmission unit: The basic transmission unit may be a symbol block (alternatively called a symbol), which in general includes a redundancy portion (referred to as the CP) and an information (for example, data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (for example, data) portion may be flexible and configurable. Another possible parameter relating to a symbol block that may be defined is ratio of CP duration to information (for example, data) duration. In some embodiments, the symbol block length may be adjusted according to: channel condition (for example, multi-path delay, Doppler); and/or latency requirement; and/or available time duration. As another example, a symbol block length may be adjusted to fit an available time duration in the frame.
(6) Flexible switch gap: A frame may include both a DL portion for DL transmissions from a base station, and a UL portion for UL transmissions from UEs. A gap may be present between each UL and DL portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### a-6. Cell, Carrier, Bandwidth Parts, and Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, for example, the center or lowest or highest frequency of the carrier. A carrier may be on licensed or unlicensed spectrum. Wireless communication with the device may also or instead occur over one or more bandwidth parts (BWPs) or certain subband comprising one or more Physical Resource Blocks (PRBs) or other frequency domain basic units. For example, a carrier may have one or more BWPs. More generally, wireless communication with the device may occur over spectrum. The spectrum may comprise one or more carriers and/or one or more BWPs.

A cell may include one or multiple DL resources and optionally one or multiple UL resources, or a cell may include one or multiple UL resources and optionally one or multiple DL resources, or a cell may include both one or multiple DL resources and one or multiple UL resources. As an example, a cell might only include one DL carrier/BWP, or only include one UL carrier/BWP, or include multiple DL carriers/BWPs, or include multiple UL carriers/BWPs, or include one DL carrier/BWP and one UL carrier/BWP, or include one DL carrier/BWP and multiple UL carriers/BWPs, or include multiple DL carriers/BWPs and one UL carrier/BWP, or include multiple DL carriers/BWPs and multiple UL carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, for example, a carrier may have a bandwidth of 20 megahertz (MHz) and consist of one BWP, a bandwidth of 80 MHz and consist of two adjacent contiguous BWPs, and/or the like. In other embodiments, a BWP may have one or more carriers, for example, a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmWave band, the second carrier may be in a low band (such as 2 GHz band), the third carrier (if it exists) may be in terahertz (THz) band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (for example, base station) dynamically, for example, in physical layer control signaling such as downlink control information (DCI), or semi-statically, for example, in RRC signaling or in the MAC layer, or be predefined based on the application scenario; or be determined by the UE as a function of other parameters that are known by the UE, or may be fixed, for example, by a standard.

### a-7. Timing Reference Point

In current networks, frame timing and synchronization is established based on synchronization signals, such as a primary synchronization signal (PSS) and a secondary synchronization signal (SSS). Notably, known frame timing and synchronization strategies involve adding a timestamp, for example, (xxo:yyo:zz), to a frame boundary, where xxo, yyo, zz in the timestamp may represent a time format such as hour, minute, and second, respectively.

It is anticipated that diverse applications and use cases in future networks may involve usage of different periods of frames, slots and symbols to satisfy the different requirements, functionalities and quality of service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

In some embodiments, frame timing alignment and/or realignment may comprise a timing alignment and/or realignment in terms of a boundary of a symbol, a slot or a sub-frame within a frame; or a frame (thus the frame timing alignment/realignment here is more general, not limiting to the cases where a timing alignment/realignment is from a frame boundary only). Also, relative timing to a frame or frame boundary may be interpreted in a more general sense, that is, the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In some embodiments, a network device such as a base station 102, referenced hereinafter as a TRP 102, may transmit signaling that carries a timing realignment indication message. The timing realignment indication message includes information allowing a receiving UE 114 to determine a timing reference point. On the basis of the timing reference point, transmission of frames, by the UE 114, may be aligned. In some embodiments, the frames that become aligned are in different sub-bands of one carrier frequency band. In some other embodiments, the frames that become aligned are found in neighboring carrier frequency bands.

On the TRP 102 side, one or more types of signaling may be used to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 114 of a configuration of a timing reference point. References, hereinafter, to the term “UE” may be understood to represent reference to a broad class of generic wireless communication devices within a cell (that is, a network receiving node, such as a wireless device, a sensor, a gateway, a router, or the like), that is, being served by the TRP 102. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, for example, the start of the current frame. Alternatively, the timing reference point may be expressed in terms of an absolute timing based on certain standards timing reference such as a global navigation satellite system (GNSS) (for example, global positioning system (GPS)), coordinated universal time (“UTC”), and/or the like. In the absolute timing version of the timing reference point, a timing reference point may be explicitly stated.

The timing reference point may be shown to allow for timing adjustments to be implemented at the UEs 114. The timing adjustments may be implemented for improvement of accuracy for a clock at the UE 114. Alternatively, or additionally, the timing reference point may be shown to allow for adjustments to be implemented in future transmissions made from the UEs 114. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs 114 and one or more BSs 102 (in a cell or a group of cells).

At UE 114 side, the UE 114 may monitor for the timing realignment indication message. Responsive to receiving the timing realignment indication message, the UE 114 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 114 may cause the TRP 102 to transmit the timing realignment indication message by transmitting, to the TRP 102, a request for a timing realignment, that is, a timing realignment request message. Responsive to receiving the timing realignment request message, the TRP 102 may transmit, to the UE 114, a timing realignment indication message including information on a timing reference point, thereby allowing the UE 114 to implement a timing realignment (or/and a timing adjustment including clock timing error correction), wherein the timing realignment is in terms of (for example, a starting boundary of) a symbol, a slot or a sub-frame within a frame; or a frame for UEs 114 and TRP(s) 102 in a cell (or a group of cells).

In some embodiments, a TRP 102 associated with a given cell may transmit a timing realignment indication message. The timing realignment indication message may include enough information to allow a receiver of the message to obtain a timing reference point. The timing reference point may be used, by one or more UEs 114 in the given cell, when performing a timing realignment (or/and a timing adjustment including clock timing error correction).

In some embodiments, the timing reference point may be expressed, within the timing realignment indication message, relative to a frame boundary (where a frame boundary may be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, that is, Δt, subsequent to a frame boundary for a given frame. Since the frame boundary is important to allowing the UE 114 to determine the timing reference point, it is important that the UE 114 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a master information block (MIB) and the remaining four bits of the 10 bits for the SFN may be carried in a physical broadcast channel (PBCH) payload.

Optionally, the timing realignment indication message may include other parameters. The other parameters may, for example, include a minimum time offset. The minimum time offset may establish a duration of time preceding the timing reference point. The UE 114 may rely upon the minimum time offset as an indication that DL signaling, including the timing realignment indication message, will allow the UE 114 enough time to detect the timing realignment indication message to obtain information on the timing reference point.

### a-8. Precoding

Precoding as used herein may refer to any coding operation(s) or modulation(s) that transform an input signal into an output signal. Precoding may be performed in different domains, and typically transform the input signal in a first domain to an output signal in a second domain. Precoding may include linear operations.

### a-9. Multiple-Input Multiple-Output (Mimo)

MIMO technology allows an antenna array of multiple antennas to perform signal transmissions and receptions to meet high transmission rate requirement. The UEs 114 and/or TRPs 102 may use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above TRP 102 configured with a large number of antennas has gained wide attentions from the academia and the industry. In the large-scale MIMO system, the TRP 102 may be generally configured with more than ten antenna units (such as antennas 148 shown in FIG. 2A), and serves for dozens of the UE 114 in the meanwhile. A large number of antenna units of the TRP 102 may greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the TRP 102 of each cell may communicate with many UEs 114 in the cell on the same time-frequency resource at the same time, thus greatly increasing the spectrum efficiency. A large number of antenna units of the TRP 102 also enable each user to have improved spatial directivity for UL and DL transmission, so that the transmitting power of the TRP 102 and/or a UE 114 is obviously reduced, and the power efficiency is greatly increased. When the antenna number of the TRP 102 is sufficiently large, random channels between each UE 114 and the TRP 102 may approach to be orthogonal, and the interference between the cell and the users and the effect of noises may be eliminated. The plurality of advantages described above enable the large-scale MIMO to have a magnificent application prospect.

A MIMO system may include a receiver connected to a receiving (Rx) antenna, a transmitter connected to transmitting (Tx) antenna, and a signal processor connected to the transmitter and the receiver. Each of the Rx antenna and the Tx antenna may include a plurality of antennas. For instance, the Rx antenna may have a uniform linear array (ULA) antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:

Panel: unit of antenna group, or antenna array, or antenna sub-array which may control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, antenna port(s) identifier, channel state information reference signal (CSI-RS) resource identifier, SSB resource identifier, sounding reference signal (SRS) resource identifier, codebook indication, beam direction indication, other reference signal resource identifier, and/or the like.

### A-10. Integrated Terrestrial Network (Tn) and Non-Terrestrial Network (Ntn)

A terrestrial communication system may also be referred to as a land-based or ground-based communication system, although a terrestrial communication system may also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communications using 5G technology and/or later generation wireless technology (for example, 6G or later). In some examples, the terrestrial communication system may also accommodate some legacy wireless technology (for example, 3G or 4G wireless technology). The non-terrestrial communication system may be a communications using the satellite constellations like conventional geostationary orbit (GEO) satellites which utilizing broadcast public/popular contents to a local server, low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or unmanned aerial vehicles (UAVs) (or unmanned aerial system (UAS)) achieving a dense deployment since their coverage may be limited to a local area, such as airborne, balloon, quadcopter, drones, and/or the like. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging three dimensional (3D) vertical networks consist of many moving (other than geostationary satellites) and high altitude access points such as UAVs, HAPs and VLEOs.

a-11. Artificial Intelligence or Machine Learning (Ai/Ml)

AI technologies may be applied in communication, including AI/ML based communication in the physical layer and/or AI/ML based communication in the higher layer, for example, MAC layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, for example to optimize the functionality in the MAC layer, for example intelligent TRP management, intelligent beam management, intelligent channel resource allocation, intelligent power control, intelligent spectrum utilization, intelligent modulation and coding scheme (MCS), intelligent HARQ strategy, intelligent transmit/receive (Tx/Rx) mode adaption, and/or the like.

The following are some terminologies which are used in AI/ML field:

### Data Collection:

Data is the very important component for AI/ML techniques. Data collection is a process of collecting data by the network nodes, management entity, or UE for the purpose of AI/ML model training, data analytics and inference.

### AI/ML Model Training:

AI/ML model training is a process to train an AI/ML Model by learning the input/output relationship in a data driven manner and obtaining the trained AI/ML Model for inference.

### AI/ML Model Inference:

A process of using a trained AI/ML model to produce a set of outputs based on a set of inputs.

### AI/ML Model Validation:

As a sub-process of training, validation is used to evaluate the quality of an AI/ML model using a dataset different from the one used for model training. Validation may help selecting model parameters that generalize beyond the dataset used for model training. The model parameter after training may be adjusted further by the validation process.

### AI/ML Model Testing:

Similar with validation, testing is also a sub-process of training, and it is used to evaluate the performance of a final AI/ML model using a dataset different from the one used for model training and validation. Differently from AI/ML model validation, testing do not assume subsequent tuning of the model.

### Online Training:

Online training means an AI/ML training process where the model being used for inference is typically continuously trained in (near) real-time with the arrival of new training samples.

### Offline Training:

An AI/ML training process where the model is trained based on collected dataset, and where the trained model is later used or delivered for inference.

### AI/ML Model Delivery/Transfer:

A generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### Life Cycle Management (LCM):

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in NR air-interface.

Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring may be based on inference accuracy, including metrics related to intermediate key performance indicators (KPIs), and it may also be based on system performance, including metrics related to system performance KPIs, for example, accuracy and relevance, overhead, complexity (computation and memory cost), latency (timeliness of monitoring result, from model failure to action) and power consumption. Moreover, data distribution may shift after deployment due to the environment changes, thus the model based on input or output data distribution may also be considered.

### Supervised Learning:

The goal of supervised learning algorithms is to train a model that maps feature vectors (inputs) to labels (output), based on the training data which includes the example feature-label pairs. The supervised learning may analyze the training data and produce an inferred function, which may be used for mapping the inference data.

Supervised learning may be further divided into two types: Classification and Regression. Classification is used when the output of the AI/ML model is categorical, that is, with two or more classes. Regression is used when the output of the AI/ML model is a real or continuous value.

### Unsupervised Learning:

In contrast to supervised learning where the AI/ML models learn to map the input to the target output, the unsupervised methods learn concise representations of the input data without the labelled data, which may be used for data exploration or to analyze or generate new data. One typical unsupervised learning is clustering which explores the hidden structure of input data and provide the classification results for the data.

### Reinforce Learning:

Reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent may take the next action based on the received reward and new state in the environment. During the training phase, the agent interacts with the environment to collect experience. The environments often mimicked by the simulator since it is expensive to directly interact with the real system. In the inference phase, the agent may use the optimal decision-making rule learned from the training phase to achieve the maximal accumulated reward.

### Federated Learning:

Federated learning (FL) is a machine learning technique that is used to train an AI/ML model by a central node (for example, server) and a plurality of decentralized edge nodes (for example, UEs, next Generation NodeBs, “gNBs”).

According to the wireless FL technique, a server may provide, to an edge node, a set of model parameters (for example, weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure are performed multiple iterations until the global AI/ML model is considered to be finalized, for example, the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, and/or the like. For the MAC layer, the AI communication may aim to utilize the AI capability for learning, prediction, and/or making a decision to solve a complicated optimization problem with possible better strategy and/or optimal solution, for example, to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, intelligent transmission/reception mode adaption, and/or the like.

An AI architecture may involve multiple nodes, where the multiple nodes may possibly be organized in one of two modes, that is, centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, for example, distributed machine learning and federated learning. In some embodiments, an AI architecture may comprise an intelligent controller which may perform as a single agent or a multi-agent, based on joint optimization or individual optimization. New protocols and signaling mechanisms are desired so that the corresponding interface link may be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, for example, to optimize one or more components of the air interface, will be referred to herein as an “AI enabled air interface”. In some embodiments, there may be two types of AI operation in an AI enabled air interface: both the network and the UE implement learning; or learning is only applied by the network.

### B. Sensing in Communication System

### B-1. Sensing Technologies

As described above, the communication system 100 or communication devices thereof often need to or prefer to understand the environment, which may be achieved via sensing.

Sensing is a technology of obtaining surrounding information, such as the information of an object including, for example, the object's location, speed, distance, orientation, shape, texture, and/or the like. Generally, sensing may be broadly classified as:
RF sensing: Sending a RF signal and obtaining the surrounding information by receiving and processing of this RF signal or the echoed or otherwise reflected RF signal; and
Non-RF sensing: Obtaining surrounding information via means using non-RF signals such as video camera or other sensors.

RF sensing may be further classified as:
Active sensing (also denoted “device-based sensing”): A sensing device sends a RF signal to a target device. The target device detects the RF signal, obtains sensed information from the RF signal or by measuring some intermediate information thereof, and then feeds the sensed information back to the sensing device.
Passive sensing (also denoted “device-free sensing”): A sensing device sends a RF signal to an object, detects the echo of the RF signal (that is, the reflected RF signal), and obtains the sensed info from the echo.

An example of passive sensing is the radar system, wherein a sensing device may send a RF signal to localize, detect, and track a target object. A radar system is typically implemented as a standalone system for a specific application.

In passive sensing, the object such as ambient IoT devices (which are smaller and cheaper IoT devices compared to traditional IoT devices) may or may not contain certain identifier (ID) information (such as RF tags).

Generally, from the transmitter and receiver point of view, there are three types of sensing:
Monostatic sensing, wherein the transmitter and receiver are the same device;
Bi-static sensing, wherein the transmitter and receiver are different devices; for example, a TRP 102 may act as the transmitter and send the RF signals for sensing, and a UE 114 may act as the receiver and receive the RF signals;
Multi-static sensing, which may be decomposed into a plurality of bi-static Tx-Rx pairs; for example, a TRP 102 may send the RF signals for sensing, and two UEs 114 (such as UE1, UE2) may receive the RF signals, thereby forming a first Tx-Rx pair between the TRP 102 and UE1, and a second Tx-Rx pair between the TRP 102 and UE2.

### B-2. Ue Positioning

UE position information is often used in cellular communication networks to improve various performance metrics for the network. Such performance metrics may include, for example, capacity, agility, efficiency, and/or the like. The improvement may be achieved when elements of the network exploit the position, the behavior, the mobility pattern, and/or the like, of the UE 114 in the context of a priori information describing a wireless environment in which the UE 114 is operating.

As described above, sensing system may be used to help gather UE pose information, including its location in a reference system, its velocity and direction of movement in the reference system, orientation information, the information about the wireless environment, and/or the like. For example, integrated sensing and communication may be used for determining the UE pose information. In some embodiments when integrated sensing and communication is used, the system 100 may comprise a framework for information exchange between UE 114 and the sensing system/sensing coordinator and corresponding interaction protocols.

Simultaneous localization and mapping (SLAM) can keep tracking of UE location and simultaneously constructing and/or updating an environment map (such as the communication-parameter map described below). SLAM methods will not only enable advanced cross-reality (XR) applications but also enhance the navigation of autonomous objects such as vehicles and drones. As SLAM can simultaneously obtain UE location and the environment map, it is a promising technology to realize the sensing function in integrated sensing and communication system.

SLAM can use different types of sensors for various purposes such as obtaining visual features from the environment using two dimensional (2D) and/or 3D cameras, and obtaining ranging and/or depth information using light detection and ranging (LIDAR). Radio SLAM, which has been developed more recently, is based on RF sensors (that is, radio-signal-based sensors). Although visual-based SLAM and LIDAR-based SLAM can achieve a higher resolution environment map, they may be easily affected by weather and light conditions. On the other hand, radio-based SLAM provides a lower resolution environment map, but is not affected by weather and light.

In SLAM, all processing functions for localization/positioning and environment map construction/updating are generally performed locally at the UE side. This brings great challenges to a practical implementation of SLAM because of the rather limited computing capability and power consumption of the UE 114. In addition, the locally processed SLAM does not utilize the information from other nodes in the network, for example, information from the BS or TRP 102. The resolution of the obtained environment map is usually not high.

Further terrestrial and non-terrestrial networks can enable a new range of services and applications such as earth monitoring, remote sensing, passive sensing and positioning, navigation, tracking, autonomous delivery and mobility, and/or the like. Terrestrial-networks-based sensing and non-terrestrial-networks-based sensing may provide intelligent, context-aware networks to enhance the UE experience. For example, terrestrial-networks-based sensing and non-terrestrial-networks-based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. SLAM methods will not only enable advanced cross-reality applications but also enhance the navigation of autonomous objects such as vehicles and drones. In future terrestrial and non-terrestrial networks, the measured channel data and sensing and positioning data may be obtained by large bandwidth, new spectrum, dense network, and more light-of-sight (LOS) links. Based on these data, a communication-parameter map may be drawn, where channel information is linked to its corresponding positioning or environmental information to provide an enhanced physical layer design based on this map.

The RAN 104 may provide the communication-parameter map to UE 114 for helping the UE 114 to improve its sensing function, (for example, to improve sensing accuracy or reduce sensing complexity) or assist UE communication, such as MIMO or beamforming procedures. In addition, when the location/geographical information of UE 114 changes, or the surrounding environment changes, the communication-parameter map corresponding to the UE 114 may also change. If the RAN 104 can provide the most up-to-date knowledge of communication-parameter map to UE 114 according to these changes, the processing delay or processing complexity of UE 114 may be reduced, and the performance of sensing or communication may be improved accordingly.

### C. Integrated Sensing and Communication

### C-1. Radio Detection and Ranging (Radar)

The term RADAR originates from the phrase radio detection and ranging; however, expressions with different forms of capitalization (that is, Radar and radar) are equally valid and now more common. Radar is typically used for detecting a presence and a location of an object. A radar system radiates radio frequency energy and receives echoes of the energy reflected from one or more targets. The system determines a given target based on the echoes returned from the given target. The radiated energy may be in the form of an energy pulse or a continuous wave, which may be expressed or defined by a particular waveform. Examples of waveforms used in radar include frequency modulated continuous wave (FMCW) and ultra-wideband (UWB) waveforms.

Radar systems may be monostatic, bi-static, or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

### C-2. Introduction

UE position information is often used in cellular communication networks to improve various performance metrics for the network. Such performance metrics may, for example, include capacity, agility, and efficiency. The improvement may be achieved when elements of the network exploit the position, the behavior, the mobility pattern, and/or the like, of the UE 114 in the context of a priori information describing a wireless environment in which the UE is operating.

A sensing system may be used to help gather UE information, including its location in a reference system (such as a global coordinate system, a local coordinate system, a reference system with respect to certain reference point(s), or the like), its velocity and direction of movement in the reference system, orientation information, the information about the wireless environment, and/or the like. Herein, the term “location” is also known as “position” and these two terms may be used interchangeably. Examples of well-known sensing systems include radio detection and ranging (RADAR) and light detection and ranging (LIDAR). While the sensing system may be separate from the communication system, it may be advantageous to gather the information using an integrated sensing and communication system, which may reduce the hardware (and cost) of the system as well as the time, frequency, or spatial resources needed to perform both sensing and communication functionalities. However, using the communication system hardware to perform sensing of an object (such as sensing the object and its position or localization, shape, orientation, gesture, and/or the like) and environment information is a highly challenging and open problem. The difficulty of the problem relates to factors such as the limited resolution of the communication system, the dynamicity of the environment, and the huge number of objects whose electromagnetic properties and positions are to be estimated.

Accordingly, integrated sensing and communication (ISAC; also known as integrated communication and sensing, joint sensing and communication, and other similar names) is a desirable feature in existing and future communication systems.

### C-3. Sensing Node, Sensing Management Function

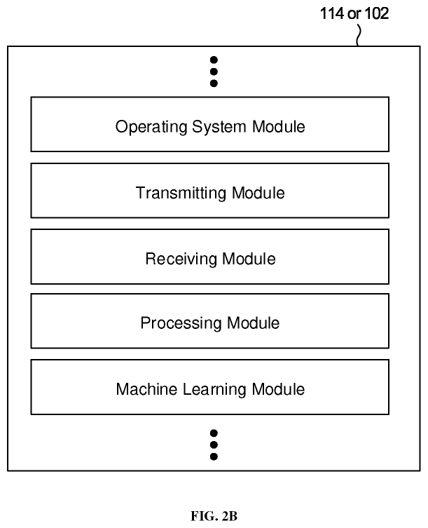

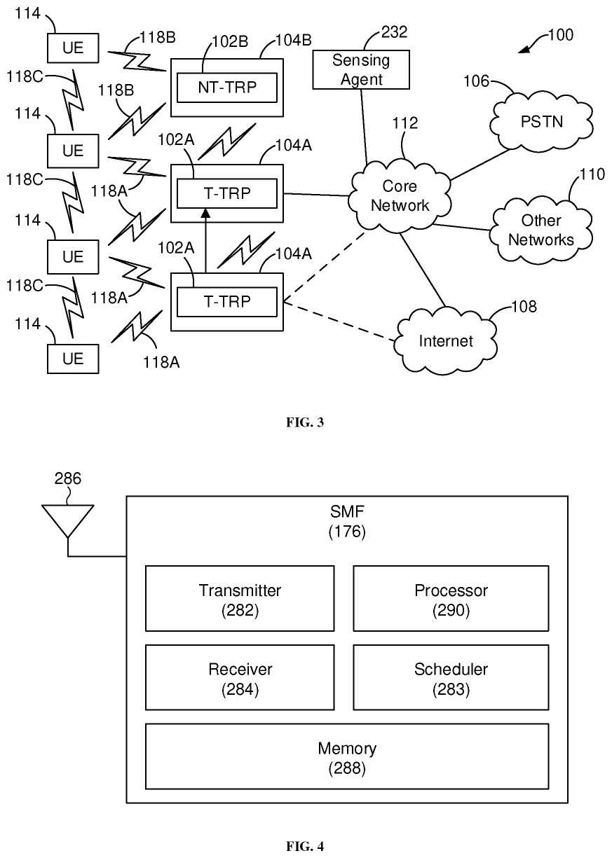

As shown in FIG. 3, any or all of the UEs 114 and TRPs 102 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 232 is an example of a sensing node that is dedicated to sensing. Unlike the UEs 114 and TRPs 102, the sensing agent 232 does not transmit or receive communication signals. However, the sensing agent 232 may communicate configuration information, sensing information, signaling information, or other information within the communication system 100. The sensing agent 232 may be in communication with the core network 112 to communicate information with the rest of the communication system 100. By way of example, the sensing agent 232 may determine the location of the UE 114, and transmit this information to the TRP 102 via the core network 112. Although only one sensing agent 232 is shown in FIG. 3, any number of sensing agents may be implemented in the communication system 100. In some embodiments, one or more sensing agents may be implemented at one or more of the RANS 104.

A sensing node may combine sensing-based techniques with reference signal-based techniques to enhance the determination of UE-related information. This type of sensing node may also be known as a sensing management function (SMF). In some networks, the SMF may also be known as a location management function (LMF). In some embodiments, the SMF may be implemented as a physically independent entity located at the core network 112 with connection to the multiple TRPs 102. In some other embodiments, the SMF may be implemented as a logical entity co-located inside a TRP 102 through logic carried out by the processor 142.

As shown in FIG. 4, the SMF 176, when implemented as a physically independent entity, includes at least one processor 290, at least one transmitter 282, at least one receiver 284, one or more antennas 286, and at least one memory 288. A transceiver, not shown, may be used instead of the transmitter 282 and receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing, or any other functionality. The processor 290 may also be configured to implement some or all of the functionality and/or embodiments described in more detail above. Each processor 290 includes any suitable processing or computing device configured to perform one or more operations. Each processor 290 may, for example, include a microprocessor, a microcontroller, a digital signal processor, a FPGA, or an ASIC.

A reference signal-based object determination technique may involve an “active” pose estimation paradigm. In an active pose estimation paradigm, the enquirer of pose information (that is, the UE 114) takes part in process of determining the pose of the enquirer. The enquirer may transmit or receive (or both) a signal specific to pose determination process. Positioning techniques based on a GNSS such as a GPS are other examples of the active pose estimation paradigm.

In contrast, a sensing technique, based on radar for example, may be considered as involving a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques may yield enhanced object determination.

The enhanced object determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information may also facilitate sub-space based sensing to reduce sensing complexity and improve sensing accuracy.

### C-4. Sensing Channel

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal, and a second set of channels may be used to transmit a communications signal. In some embodiments, each channel in the first set of channels and each channel in the second set of channels is a logical channel, a transport channel, or a physical channel.

At the physical layer, communication and sensing may be performed via separate physical channels. For example, a first physical downlink shared channel PDSCH-C is defined for data communication, while a second physical downlink shared channel PDSCH-S is defined for sensing, such as sensing data sharing for cooperative sensing, sensing reference signals, and/or the like. Similarly, separate physical uplink shared channels (PUSCHs), PUSCH-C and PUSCH-S, may be defined for UL communication and sensing. For example, PUSCH-S may be used for sensing result report and sensing data sharing.

In another example, the same PDSCH and PUSCH may be also used for both communication and sensing, with separate logical layer channels and/or transport layer channels defined for communication and sensing. Note also that control channel(s) and data channel(s) for sensing may have the same or different channel structure (format), occupy same or different frequency bands or bandwidth parts.

In a further example, a common physical downlink control channel (PDCCH) and a common physical uplink control channel (PUCCH) is used to carry control information for both sensing and communication. Alternatively, separate physical layer control channels may be used to carry separate control information for communication and sensing. For example, PUCCH-S and PUCCH-C may be used for uplink control for sensing and communication respectively, and PDCCH-S and PDCCH-C for downlink control for sensing and communication respectively.

Different combinations of shared and dedicated channels for sensing and communication, at each of the physical, transport, and logical layers, are possible.

### C-5. Half-Duplex and Full-Duplex

Communication nodes may be either half-duplex or full-duplex. A half-duplex node may not both transmit and receive using the same physical resources (time, frequency, and/or the like); conversely, a full-duplex node may transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (for example, in the millimeter wave bands), and very challenging for small and low-cost devices, such as femtocell base stations 102 and UEs 114.

The limitation of half-duplex nodes in the communications network presents further challenges toward integrating sensing and communications into the devices and systems of the communications network. For example, both half-duplex and full-duplex nodes may perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

### C-6. Sensing Signal Waveform and Frame Structure

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that may be used for a sensing signal include UWB pulse, FMCW or “chirp”, OFDM, CP-OFDM, and discrete Fourier transform spread (DFT-s)-OFDM.

### D. Fast Wakeup and Data Transmission Methods

### D-1. Fast Wakeup and Data Transmission Methods and Data Structures

In existing mobile communication systems such as 5G NR, both UE power saving and network power saving have been considered (to some extent) and discussed in, for example, the 5G NR standard, wherein different power consumption modes (such as deep sleeping, light sleeping, micro-sleeping) with different power consumption levels may be used.

For example, in 5G NR, a UE 114 may transition between three RRC states, including the RRC_CONNECTED state, the RRC_INACTIVE state, and the RRC_IDLE state. As shown in FIG. 5, when a UE 114 powers up, it first goes through cell search and initial access to establish connection with the RAN 104, wherein the UE 114 performs a RRC connection establishment procedure to establish connection with a TRP 102 of the RAN 104 for data communication and/or making/receiving phone calls. The UE 114 is then in the RRC_CONNECTED state 302. In this state, the UE 114 may use connected mode discontinuous reception (C-DRX) to periodically monitor the physical downlink control channel (PDCCH), which allows the UE 114 to reduce some activities between two PDCCH-monitoring actions, thereby reducing the UE's power consumption. For example, the C-DRX cycle may be configured to allow the UE 114 enter the micro sleep, light sleep, or deep sleep mode. As those skilled in the art understand, the micro sleep, light sleep, and deep sleep are defined based on the components that are switched off. For example, A UE 114 in deep sleep mode may turn off RF chain so that the UE 114 cannot monitor or receive control or data channels.

When the UE 114 has reduced activities for a period of time, the UE 114 may enter the RRC_INACTIVE state 304 by releasing the communication resources assigned thereto and suspending the RRC connection.

As specified in the third generation partnership project (3GPP), a UE 114 in the RRC_INACTIVE state 304 is generally in a dormant state wherein the UE 114 may turn off some communication-related components and operate with reduced power consumption. In the RRC_INACTIVE state 304, the non-access stratum (NAS) layer remains connected and RRC is not completely released.

A UE 114 does not perform transmission/receiving of a large amount of data in the RRC_INACTIVE state 304, which, instead, requires the UE 114 to transition to the RRC_CONNECTED state 302 by the RRC RESUME process and then performs data transmission.

The UE 114 may perform small data transmission (SDT; for example, monitor paging messages transmitted from the RAN 104 or transmit a small data packet) without transitioning to the RRC_CONNECTED state, thereby allowing the UE with reduced activities to save power. As specified in 3GPP, the UE 114 in the RRC_INACTIVE state 304 may perform SDT via random access (RA-SDT) or configured grant (CG) access (CG-SDT).

The UE 114 in the RRC_INACTIVE state 304 may transition to the RRC_CONNECTED state 302 by resuming the RRC connection.

When the UE 114 in the RRC_INACTIVE state 304 has no activity for a prolonged period of time, the UE 114 may release the RRC connection and enter the RRC_IDLE state 306 to have reduced paging detection and measurement frequency, thereby further reduced its power consumption. The UE 114 may transition to the RRC_CONNECTED state 302 by re-establishing the RRC connection. A UE 114 in the RRC_CONNECTED state 302 may also directly enter the RRC_IDLE state 306 after a prolonged period of time with no activity, by releasing the RRC connection.

In older mobile communication standards such as LTE, a UE 114 may only transition between the RRC_CONNECTED state 302 and the RRC_IDLE state 306 (that is, no RRC_INACTIVE state 304).

Wakeup signals (WUS) may be used to wake up a UE 114 in the RRC_INACTIVE state 304 or the RRC_IDLE state 306 to transition to the RRC_CONNECTED state 302. However, the WUS used in existing mobile communication systems may cause different wakeup time for different RRC states. Moreover, to wake up a UE 114 and start data transmission, many steps are needed in conventional methods which introduce additional activities such as:
system re-entry (such as re-synchronization, system information update, and the like) for UE 114 in the RRC_INACTIVE state 304 or the RRC_IDLE state 306, and for UE 114 with long sleeping time;
state transition for UE 114 in the RRC_INACTIVE state 304 or the RRC_IDLE state 306;
channel acquisition or channel measurements for MIMO and/or beamforming (BF);
channel quality indicator (CQI) measurement and feedback for link adaption; and
RRC configuration update.

The introduced additional activities may cause significant power consumption.

To standardize link adaptation, a mechanism with accurate channel estimation, a rich set of supported coding rates and modulation order, and flexible rate matching of channel codes, is designed in 5G NR and prior standards. Aided by channel estimation including channel quality measurements, a transmitter can dynamically change the code rate and modulation order, and inform the receiver about the MCS through an MCS index.

Current power saving designs are not quite effective in several scenarios. For example, to wake up a device and start data transmission, many steps are needed which introduce additional delay and power consumption, and undermines the eventual benefits of power saving.

Current link adaptation methods require relatively accurate channel estimation. This requires a full set of procedures to acquire channel quality, as an input to the MCS determination algorithm. However, if an accurate channel estimation cannot be obtained, or when only coarse channel estimation is available, link adaptation may fail.

According to one aspect of this disclosure, a fast wakeup and data transmission method (also called a “one-shot self-contained data transmission method” or simply a “one-shot data transmission method”) is disclosed. The fast wakeup and data transmission method uses a fast data-burst transmission method to transmit from a UE 114 to a TRP 102 (or from a TRP 102 to a UE 114) a data burst arranged in accordance with a one-shot data-burst structure, for providing a single-step wakeup and communication mechanism (also denoted “wakeup & go”). In various embodiments, a method for initial MCS and other transmission parameter determination, a progressive precoding and/or BF adaption method, and a progressive link adaption method may also be used for fast wakeup.

Herein, the fast wakeup and data transmission method is a simplified process performed by a TRP 102 and a UE 114 with at least one of the TRP 102 and UE 114 in a status with restricted or reduced power consumption in wireless communication related activities; such as in a sleep state with a restricted or reduced wireless communication capability for “wake up and go” (described later).

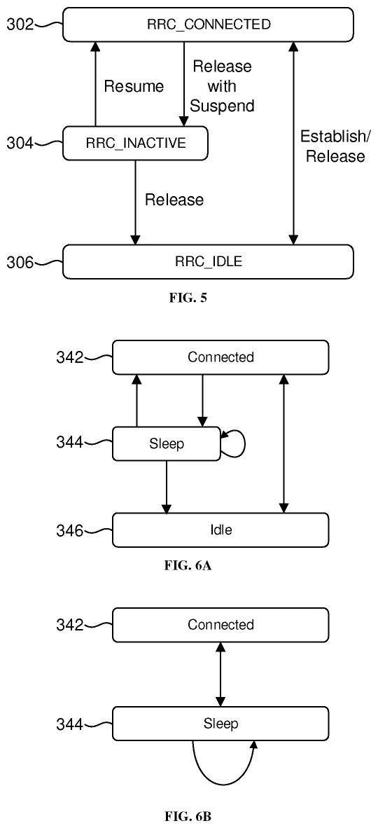

FIG. 6A shows the states of a device (such as a UE 114 or a TRP 102) according to some embodiments of this disclosure. As shown, the device may transition between a connected state 342 (which is similar to the RRC_CONNECTED state 302), a low power-consumption state or sleep state 344, and an idle state 346 (which may be similar to the RRC_IDLE state 306 although the device may enter the idle state 346 after an extended period of time of inactivity longer than the period of time of inactivity for entering the RRC_IDLE state 306). The transition between the connected state 342 and the idle state 346 is similar to that between the RRC_CONNECTED state 302 and the RRC_IDLE state 306.

In these embodiments, the sleep state 344 is an operation state or mode when one or more components of the device are switched off for energy saving. The device in the sleep state generally has significantly reduced activities, and its ability to transmitting and receiving signal, and measuring or sounding the communication channel and/or sensing the environment is also significantly reduced. Different level of sleeping turns off different components or applies low capability components, for example power amplifiers (PAS), low noise amplifier (LNAs), integrated circuits (ICs) in transmitter and receiver units, and/or the like. In some embodiments, it may be preferable to turns off as many circuitry components as possible and keeps only a few components on for maintain internal clocks and transmission/reception of necessary signals (such as LCM signals) to keep the device “alive”.

As will be described in more detail later, when the TRP 102 and/or UE 114 is in the sleep state 344, the TRP 102 and/or UE 114 may use the fast wakeup and data transmission method for rapid transmission therebetween one or more wakeup signals to wake up the “sleeping” device (that is, the TRP 102 and/or UE 114 in the sleep state), and performing data transmission therebetween before the sleeping device transitions to the connected state.

The data transmission therebetween may comprise one or more data sets, each data set comprising one or more data fields, and may be transmitted from the TRP 102 to the UE 114 (that is, DL data transmission), or from the UE 114 to the TRP 102.

For example, the TRP 102 may transmit a fast-wakeup signal and then one or more data sets to the UE 114 in the sleep state. The fast-wakeup signal comprises control information such as the time-frequency resources for the subsequent data transmission. The UE 114 uses the control information in the fast-wakeup signal and also use information (such as MIMO-related information, initial MCS, and/or the like) stored before the UE 114 entered the sleep state, to receive the data transmitted from the TRP 102 without transitioning to the connected state. The UE 114 may send an acknowledgement (ACK) to the TRP 102 indicating successful data receiving, or a negative-acknowledgement (NACK) to the TRP 102 indicating unsuccessful data receiving so that the TRP 102 may retransmit the data.

After data receiving, the UE 114 may enter an increased, less restricted, unrestricted, or even full power consumption status (with respect to wireless communication related activities) with increased or even full wireless communication capability (such as transitioning to the connected state), or may go back to sleep (that is, remaining in the sleep state) after receiving a release indication or after a predefined or preconfigured timing expires.

As another example, the UE 114 may send a wakeup preamble (functioning as a wakeup signal) to wake up the TRP 102 in the sleep state. The UE 114 then sends to the TRP 102 one or more data sets using grant-free (GF; also called “configured grant”) transmission (that is, using time-frequency resource reserved before the TRP 102 entered the sleep state. The UE 114 may wait for the ACK/NACK feedback from the TRP 102 to decide whether data retransmission is needed. Alternatively, the UE 114 may go back to sleep without waiting for the ACK/NACK feedback.

As yet another example, the UE 114 in the sleep state may send a wakeup preamble to the TRP 102 to indicate its waking up, and then sends to the TRP 102 one or more data sets using grant-free (GF) transmission (that is, using time-frequency resource reserved before the TRP 102 entered the sleep state). The UE 114 may wait for the ACK/NACK feedback from the TRP 102 to decide whether data retransmission is needed. Alternatively, the UE 114 may go back to sleep after the data-set transmission is finished without waiting for the ACK/NACK feedback.

In some embodiments, the TRP 102 may send a fast-wakeup signal and then some data to the UE 114 as described above. The UE 114 may receive the data without transitioning to the connected state, and also send some data to the TRP 102 using GF transmission at the same time, thereby achieving full duplex (FD) or subband FD. Alternatively, while the UE 114 is receiving the DL data from the TRP 102, the UE may also receive one or more updated transmission parameters from the DCI transmitted from the TRP 102, and use the one or more updated transmission parameters to send some data to the TRP 102 (that is, in granted mode) at the same time for achieving full duplex (FD) or subband FD. The DCI may comprise one or more updated transmission parameters such that the UE may continue data transmission/reception with one or more new parameters.

Similarly, the UE 114 may send a preamble and then some data to the TRP 102 using GF transmission as described above. The TRP 102 may receive the data without transitioning to the connected state, and also send some data to the UE 114 at the same time, thereby achieving full duplex (FD) or subband FD.

In some embodiments, the device (such as the UE 114) in the sleep state may perform some (such as minimum) communication-related measurements (such as channel measurements) based on the wakeup signal (for example, the reference signals (RS; such as CSI-RS, demodulation reference signal (DMRS), and/or the like) embedded in the wakeup signal). As those skilled in the art will appreciate, complete channel measurements usually require a significant amount of time, especially for MIMO with a large number of antennas. Thus, in these embodiments, the communication-related measurements performed by the device in the sleep state may be fast, partial (or incomplete) communication-related measurements (that is, only measuring a subset of one or more communication-related parameters) in order to reduce the overhead and/or the power consumption. The communication-related measurements may be fed back to the other side (such as the TRP 102) using a soft ACK/NACK. Herein a soft ACK/NACK refers to a multi-bit feedback wherein the payload thereof comprises an ACK or NACK reporting (that is, being ACK or NACK depending on the success or failure of a message reception/decoding) and channel information such as channel state information (CSI).

Alternatively or in addition, the device in the sleep state may perform the communication-related measurements based on the RS embedded in the first data set, and send the communication-related measurements to the other side so as to progressively adapt to the channel (that is, progressive link adaption) so that the subsequent data transmission/receiving may use the one or more updated communication-related parameters for improved performance. Similarly, the device in the sleep state may also perform the communication-related measurements based on the RS embedded in subsequent data sets, thereby gradually or progressively adapting to the link between the TRP 102 and UE 114.

Moreover, as will be described in more detail later, in some embodiments, the LCM signal transmitted between the TRP 102 and UE 114 may also be used for communication-related measurements, thereby enabling progressive link adaption throughout the sleep state.

As those skilled in the art will appreciate, the sleep state 344 may be similar to the RRC_INACTIVE state 304 or the RRC_IDLE state 306 in terms of how the device may enter this state (such as inactivity for a period of time), and how the device in this state may switch off one or more components for energy saving. However, the sleep state 344 is different to the RRC_INACTIVE state 304 or the RRC_IDLE state 306 in many aspects such as how the device reduces the Tx/Rx capability or turns off Tx/Rx functions and components, how the device transmits and/or receives necessary signals (such as LCM signals) to keep itself “alive”, how the device maintains information for fast wakeup, and how the device reacts to a fast-wakeup signal and immediately receives/transmits data.

In some embodiments as shown in FIG. 6B, the device may only transition from the connected state 342 to the sleep state 344 (that is, no idle state 346).

With the UE 114 and/or TRP 102 in the sleep state 344, a lifecycle management (LCM) signal may be periodically transmitted from the TRP 102 to the UE 114 (denoted “DL LCM”) and/or from the UE 114 to the TRP 102 (denoted “UL LCM”) for performing measurements (such as channel measurements, sensing measurements, and/or the like), tracking the location of the UE 114, maintaining basic synchronization between the UE 114 and the TRP 102, and/or the like, so as to keep the “sleeping” UE 114 and/or TRP 102 “alive”.

For the purpose of fast wakeup, the UE 114 and/or TRP 102 may store necessary information when entering the sleep state 344. For example, in some embodiments, the UE 114 may store necessary communication-related information that may be used for fast wakeup, such as UE connection ID, one or more predefined communication parameters for initial control and data transmission and reception such as MIMO configuration, MCS setting, neighboring TRP-related information, one or more power control parameters, and/or the like.

Thus, when waking up, the UE 114 and/or TRP 102 may immediately start data transmission using the stored communication-related information without the requirement of a channel measurement period for obtaining the current channel status and other related settings and/or parameters (such as without obtaining the current channel measurements, MIMO optimization, link adaption, and/or the like). Such stored communication-related information may be position-related, and may be obtained in various way.

Those skilled in the art will appreciate that, the communication-related information may be obtained via any suitable methods such as based on historical RF signal measurements performed by one or more UEs, via sensing such as environment sensing, integrated sensing and communication, SLAM, surveying, and/or the like. For example, as described above, the TRPs 102 (or the RAN 104) may collect and use their own communication-related information (such as channel and/or sensing data), and/or collect and use communication-related information from UE 114. The TRPs 102 and/or the UEs 114 may also track the positions of the UEs 114. Therefore, the TRPs 102 (or the RAN 104) may use the collected communication-related information (such as measured channel data and sensing and positioning data) to build and repeatedly update a higher-resolution communication-parameter map (also called a “RF map”) of a site or an area, where channel information is linked to its corresponding positioning or environmental information to provide an enhanced physical layer design based on this map.

The TRPs 102 may repeatedly (such as periodically or when needed) send to UEs 114, or at least send to UEs 114 before they enter the sleep state, the communication-parameter map or a portion thereof around the current location of each UE 114.

The UE 114 stores the received communication-parameter map or the portion thereof for later fast wakeup. Generally, when a UE 114 is waking up, the UE 114 has limited prior-channel knowledge. Thus, the UE 114 may obtain the communication-related information around its current location from its stored communication-parameter map or the portion thereof so as to immediately transmit or receive data to or from the TRP 102. In the following, the UE's stored communication-parameter map or the portion thereof are collectively denoted the UE's communication-parameter map for ease of description.

As shown in FIG. 7, a communication-parameter map 372 is related to a geographic map 362 of a site or an area.

Herein, the term “communication-parameter map” represents communication-related information such as radio environment information, and may also be referred to as a radio environmental map, a radio frequency (RF) map, a radio map, a radio-based map, a radio-signal-based map, a wireless-signal-based map, or other maps with similar meanings, and all of these similar-meaning terms may be used interchangeably in this disclosure.

Herein, the term “geographic map” used herein represents geography and/or geometry information, and may also be referred to as location/geometry/geographic information or map (G-map), or some intermediate results after processing of location/geometry/geography information, or other maps with similar meanings. In this disclosure, the terms “geographic map” and “G-map” may be used interchangeably.

Moreover, the term “map” used herein represents a form of indication, and can also be replaced by other names such as list, matrix, group, set, range, area, relationship, lookup table, information, and/or the like. The term “mapping” represents a relationship, and can also be replaced by other names such as relationship, matching, lookup table, and/or the like.

A further description of such terms and the details of such maps can be found in PCT International Application Serial No. PCT/CN2023/130336, entitled “METHOD, APPARATUS, AND SYSTEM FOR MAPPING BETWEEN RADIO ENVIRONMENT INFORMATION AND GEOMETRY INFORMATION”, filed on Nov. 8, 2023, the content of which is incorporated herein by reference in its entirety.

The geographic map 362 is partitioned into one or more subareas or zones 364. Each zone 364 comprises necessary geographic information such as 2D and/or 3D location of the zone 364, surrounding geometric information of the zone 364, geometric indication of the zone 364 with respect to a reference point, preprocessed geometry or geography, and/or the like.

The communication-parameter map 372 comprises one or more entries 374 (also called “blocks” or “elements”) with each entry 374 related to one or more zones 364 having similar communication-related information such as ray tracing or multi-path information, channel information, beamforming information (for example, absolute beam angle, relative beam angle, beam gradient, beam width, and/or the like) of one or multiple beams, one or more MIMO parameters, a MCS such as a long-term MCS, path loss, one or more power-control parameters such as one or more long-term power-control parameters, and/or the like, and stores such communication-related information for the related one or more zones 364. Thus, when an entry of the communication-parameter map 372 (such as the entry 374A in FIG. 7) is related to multiple zones of the geographic map 362 (such as zones 364A and 364B in FIG. 7), the multiple zones 364A and 364B have similar communication-related information. Moreover, although the geographic map 362 and the zones 364 shown in FIG. 7 are in rectangular shapes, in various embodiments, the geographic map 362 and the zones 364 thereof may be in any suitable shapes (which may be regular shapes and/or irregular shapes) and/or in any suitable forms. Similarly, the communication-parameter map 372 may also be in any suitable shapes and/or in any suitable forms such as a list, a lookup table, an array, a matrix, a 2D or 3D map, and/or the like.

Each entry 374 of the communication-parameter map 372 may store the communication-related information for the related one or more zones 364 without storing the geographic information of the related one or more zones 364, in which case the UE 114 may need to store both the geographic map 362 and the communication-parameter map 372 (or a portion of the two maps around the UE's current position).

Alternatively or additionally, each entry 374 of the communication-parameter map 372 may store the geographic information of the related one or more zones 364 and the communication-related information therefor, in which case the UE 114 may only store the communication-parameter map 372 or a portion thereof, and may not need to store the geographic map 362.

As disclosed in U.S. Provisional Patent Application Ser. No. 63/543,378, the content of which is incorporated herein by reference in its entirety, a UE 114 may perform a fast wakeup and data transmission method for fast wakeup and one-shot data burst transmission.

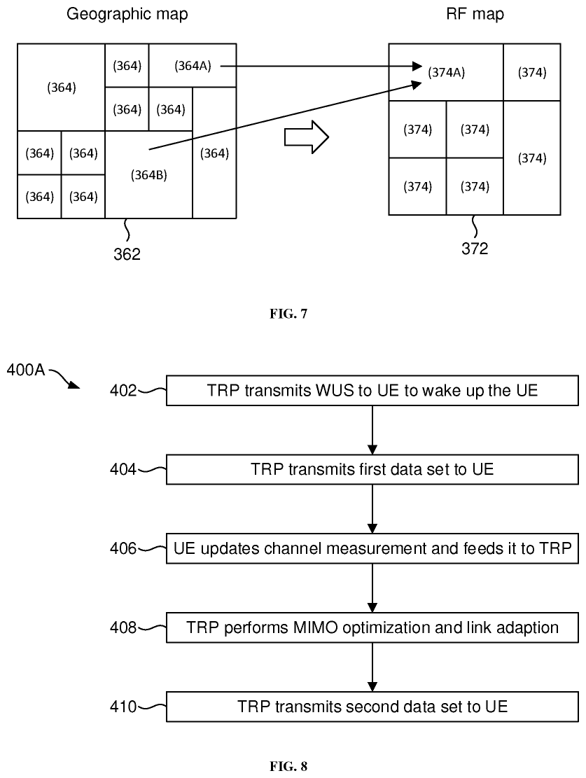

FIG. 8 is a flowchart showing the steps of a fast wakeup and data transmission method 400A performed by a TRP 102 and a UE 114 to wake up the UE 114 in the sleep state 344, and transmit one or more DL data sets from the TRP 102 to the UE 114 (that is, DL data transmission) without state transition, according to some embodiments of this disclosure.

At step 402, the UE 114 is woken up by, for example, a fast-wakeup signal sent from the TRP 102 to the UE 114. The fast-wakeup signal provides different wakeup time budgets, for example, depend on different sleeping lengths. In these embodiments, the fast-wakeup signal carries control information such as an indication of the time-frequency resource for transmission of a first data set. The fast-wakeup signal may also carry additional information such as timing indication and one or more initial transmission parameters such as MCS, quasi co-located (QCLed) beamforming, one or more QoS related parameters (for example, one or more latency requirements, one or more reliability requirements, and/or the like), and/or the like. Those skilled in the art will appreciate that, in some embodiments, such additional information may be stored in the communication-parameter map, and thus the fast-wakeup signal does not need to carry the additional information.

At step 404, a first DL data set having one or more DL data fields is transmitted from the TRP 102 to the UE 114. The first DL data set is organized in accordance with a self-contained data-burst structure, which comprises a self-contained multi-purpose reference signal (RS; such as CSI-RS, demodulation reference signal (DMRS), or the like) for channel estimation, channel acquisition, phase noise compensation, time and frequency synchronization, and/or the like.

In some embodiments, the transmission of the first DL data set is in accordance with the control information in the fast-wakeup signal and the communication-parameter map (such as using an initial BF/MIMO configuration, an initial MCS, and an initial power control in accordance with the information in the fast-wakeup signal and the communication-parameter map).

At step 406, the UE 114 uses the information retrieved from the fast-wakeup signal and the communication-parameter map to receive the first DL data set (that is, no separate RS transmission period and thus no channel measurement updates after the fast-wakeup signal and before first data transmission), and performs channel measurements based on the received first data set. For example, channel state information (CSI) may be updated based on the received first data set (or the RS therein), the DMRS, the decoded data, the new environment/channel sensing results, and/or the like. The updated channel measurements are fed back to the TRP 102.

At step 408, the TRP 102 uses the updated channel measurements for optimizing the connection between the UE 114 and TRP 102 such as BF optimization, MIMO optimization, link adaption, and/or the like for subsequent data transmission such as transmission of a second data set. Those skilled in the art will appreciate that the “optimization” at this step is based on the updated channel measurements and does not necessarily achieve the optimized results that maximize the data transmission performance (which will be ultimately achieved in the connected state). However, such a “limited” optimization may be repeated with subsequent data transmissions to achieve progressive link adaption.

For example, in the BF and/or MIMO optimization, the MCS may be adjusted based on the updated channel measurements for subsequent data transmission. Moreover, the BF and/or MIMO optimization may be based on the one or more updated channel measurements, one or more new environment and/or channel sensing results, required data rate, one or more power saving requirements, and/or the like.

At step 410, the TRP 102 sends the one or more optimized communication parameters obtained at step 408 to the UE 114 and uses the one or more optimized communication parameters for second data transmission to the UE 114. Accordingly, the UE 114 transitions to the connected state 342 and receives the second data transmission from the TRP 102.

Thus, the fast wakeup and data transmission method 400A provides a method for immediate communication after wakeup to achieve “arrive and go” (that is, immediate data transmission after arrival of the fast-wakeup signal) without state transition (that is, before transiting from the sleep state 344 to the connected state 342).

Those skilled in the art will appreciate that, in some embodiments, steps 406 to 410 may not be performed. In other words, the UE 114 may go back to “sleep” after receiving the first data set.

In some embodiments, step 410 may not be performed. In other words, after receiving the first data set, the UE 114 may updates channel measurement and feeds it to TRP, and then go back to “sleep”. The TRP 102 may perform step 408 for MIMO optimization and link adaption but would not perform step 410 to transmit any more data sets.

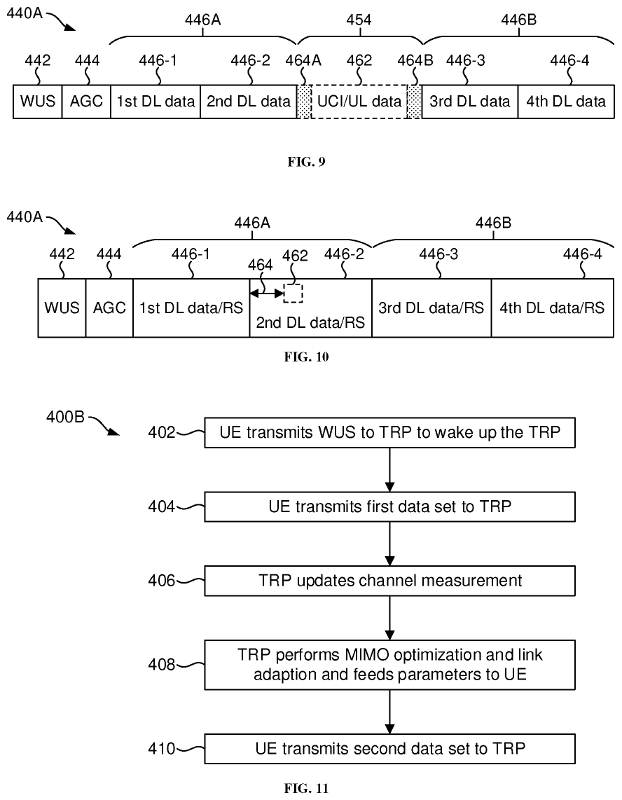

FIG. 9 shows the structure of the DL data burst 440A transmitted from the TRP 102 to the UE 114 in the fast wakeup and data transmission method 400A, according to some embodiments of this disclosure. As shown, the DL data burst 440A comprises a plurality of fields such as a fast-wakeup signal 442, an optional automatic gain control (AGC) head 444, and one or more DL data fields 446 (each may comprise one or more RS), each may take one or more basic time-domain scheduling units such as one or more slots, one or more sub-slots, or one or more symbols. As will be described in more detail later, the one or more DL data fields 446 may be partitioned into a first data set 446A and a second data set 446B transmitted using different parameters.

In these embodiments, the fast-wakeup signal 442 is in a simplified DCI format (for example, with less fields or bits compared to DCI of regular scheduling, which may be feasible because the fast-wakeup signal 442 is used to schedule initial transmission with estimated channel condition and because of reduced transmission capabilities such as MIMO, bandwidth, MCS, and/or the like), and may be considered as a scheduling request signal. In some embodiments, the fast-wakeup signal 442 comprises an indication of the time-frequency resource assigned for the first DL data set 446A.

In various embodiments, the fast-wakeup signal 442 may be a single WUS, or may be a two-stage WUS including a first-stage WUS such as a first-stage paging signal for waking up the receiving device (such as the UE 114) and a second-stage WUS such as a second-stage paging signal for scheduling the transmission of the one or more DL data fields 446.

More specifically, the second-stage WUS may comprise the indication of time-frequency resource, the initial BF and/or MIMO information, initial MCS, HARQ, and/or the like for the transmission of the first data set 446A. For example, the second-stage WUS may comprise simplified DCI (including the total number of one or more slots and/or the indices of one or more slots, bandwidth, carrier index or indication, and/or the like), or may comprise information related to a subsequent PDCCH (which comprises the simplified DCI indicating the time-frequency resource for the transmission of the first data set 446A).

Optionally, the second-stage WUS may also comprise indication of positioning reference signal (PRS), CSI-RS, and/or other measurement reference signal configurations. Such measurement reference signal configurations may be used for channel measurements which are fed back to the TRP 102 after the first data transmission (such as the first data set 446A shown in FIG. 9; described in more detail later) so that the TRP 102 may update one or more communication-related parameters for use in subsequent data transmission (such as the second data set 446B shown in FIG. 9) with improved performance.

Optionally, the second-stage WUS may further comprise an absolute timing reference.

The use of the two-stage fast-wakeup signal may further reduce wakeup signal detection power consumption because the second-stage WUS may only be performed once the first-stage WUS is successfully detected. Since the first-stage WUS does not contain control information, it may simply be, for example, a sequence or other types of signatures. Of course, in some embodiments, the fast-wakeup signal 442 may be a single-stage WUS containing, for example, above-described control information and the UE ID.

The AGC head 444 allows the UE 114 to adjust dynamical range of the received power. The AGC head 444 is optional, meaning that, in some embodiments, the data burst 440A may not comprise the AGC head 444.

The fast-wakeup signal 442 and the optional AGC head 444 are transmitted at step 402 (although the AGC head 444 may alternatively be considered as transmitted at step 404).

In some embodiments when the data burst 440A comprises a plurality of DL data fields 446 (such as DL data fields 446-1 to 446-4 shown in FIG. 9), the DL data fields 446 may be partitioned into, for example, a first DL data set 446A of one or more DL data fields 446-1 and 446-2 (transmitted at step 404), and a second DL data set 446B of one or more DL data fields 446-3 and 446-4 (transmitted at step 410). The first DL data set 446A and the second DL data set 446B are separated in time by a time period 454 for the UE 114 to transmit to the TRP 102 a UL feedback comprising uplink control information (UCI) and/or UL data 462 (represented using dotted line). A time gap 464 (denoted a “DL/UL switch gap”) may be maintained between neighboring data set and the UCI/UL data 462, such as a time gap 464A between the first DL data set 446A and the UCI/UL data 462, and a time gap 464B between the UCI/UL data 462 and the second DL data set 446B, for reducing or eliminating interference. The time gaps 464 may be configured based on for example the switching time required by device, propagation delay, and/or the like.

In some embodiments, each of one or more DL data fields 446 may comprise one or more data symbols and one or more RS symbols, wherein the one or more RS symbols may comprise any suitable RS such as DMRS, phase tracking reference signal (PTRS), channel state information reference signal (CSI-RS), and/or the like. Moreover, the one or more RS symbols may be in any suitable locations in the DL data field 446 such as in dedicated symbol locations or multiplexed with the data symbols in a same OFDM symbol.

FIG. 10 shows the structure of the DL data burst 440A transmitted from the TRP 102 to the UE 114 in the fast wakeup and data transmission method 400A, according to some embodiments of this disclosure, wherein the TRP 102 has full duplex capability or subband full duplex capability. The DL data burst 440A comprises a plurality of fields such as a WUS 442, an optional AGC head 444, and one or more DL data fields 446 (such as DL data fields 446-1 to 446-4), which are similar to those shown in FIG. 9. Similarly, the DL data fields 446 may be partitioned into a first DL data set 446A of one or more DL data fields 446-1 and 446-2 (transmitted at step 404), and a second DL data set 446B of one or more DL data fields 446-3 and 446-4 (transmitted at step 410).

A UCI and UL data field 462 (similar to that shown in FIG. 9) may be transmitted from the UE 114 to the TRP 102 within the time duration of the first DL data set 446A (such as within the time duration of the second DL data field 446-2 after a delay 464 from the starting time of the second DL data field 446-2), and may occupy a portion of the bandwidth (as shown in FIG. 10) or the entire bandwidth. The time/frequency resource used for transmission of the UCI and UL data field 462 in DL data transmission period may be pre-configured or signaled by wake up signal or follow up DCI. The delay 464 may be configured by RRC and may be updated by DCI.

FIG. 11 is a flowchart showing the steps of a fast wakeup and data transmission method 400B performed by a TRP 102 and a UE 114 to wake up the TRP 102 in the sleep state 344, and transmit one or more UL data sets from the UE 114 to the TRP 102 (that is, UL data transmission) before the TRP 102 transitions to the connected state 342, according to some embodiments of this disclosure.

At step 402, the TRP 102 is woken up by, for example, a fast-wakeup signal (such as a wakeup preamble) sent from the UE 114 to the TRP 102. At step 404, a first UL data set having one or more UL data fields (that is, the first data transmission) is transmitted from the UE 114 to the TRP 102. The first UL data set is organized in accordance with a self-contained data-burst structure, which comprises a self-contained multi-purpose RS including channel estimation, channel acquisition, phase noise compensation, time and frequency synchronization, and/or the like.

In these embodiments, the data transmission may start with grant-free (also denoted “configured grant”) transmission (for example, the transmission in the first one or more slots being grant-free transmission) with information (such as MIMO-related information) obtained from the communication-parameter map stored in the UE 114, and the subsequent data transmission may be grant-based transmission.

At step 406, the TRP 102 receives the first UL data set and performs the channel measurements based on the first UL data set. For example, CSI may be updated based on the received first UL data set (or the RS therein), the DMRS, the decoded data, the new environment/channel sensing results, and/or the like.

At step 408, the TRP 102 uses the updated channel measurements for optimizing the connection between the UE 114 and TRP 102 such as BF optimization, MIMO optimization, link adaption, and/or the like for subsequent UL data transmission (such as a second UL data set). Those skilled in the art will appreciate that the “optimization” at this step is based on the updated channel measurements and does not necessarily achieve the optimized results that maximize the data transmission performance (which will be ultimately achieved in the connected state). However, such a “limited” optimization may be repeated with subsequent data transmissions to achieve progressive link adaption.

For example, in the BF and/or MIMO optimization, the MCS may be adjusted based on the updated channel measurements for subsequent UL data transmission. Moreover, the BF and/or MIMO optimization may be based on the one or more updated channel measurements, one or more new environment and/or channel sensing results, required data rate, one or more power saving requirements, and/or the like. The TRP 102 may send the updated one or more channel measurements and/or optimized one or more communication parameters obtained at steps 406 and 408 to the UE 114.

After the first data transmission step 404, the UE 114 may go back to “sleep” (that is, remaining in the sleep state 344) without waiting for TRP's feedback.

Alternatively, at step 410, the UE 114 may receive the TRP's feedback to decide whether retransmission is required. The UE 114 also receives the optimized one or more communication parameters from the TRP 102, and uses the received optimized one or more communication parameters to transmit more data sets.

FIG. 12 shows the structure of the UL data burst 500A for transmitting from the UE 114 to the TRP 102 in the fast wakeup and data transmission method 400B, according to some embodiments of this disclosure. As shown, the UL data burst 500A comprises a plurality of fields such as a fast-wakeup preamble 502 (or simply denoted a “preamble”) comprising a fast-wakeup signal to wake up the TRP 102, an optional AGC head 504, and a set of one or more UL data fields 506 (including, for example, UL data fields 506-1 and 506-2, each of which may comprise one or more RS). The preamble 502 and the optional AGC head 504 are transmitted at step 402 shown in FIG. 11, and the UL data set 506 is transmitted at step 404 (that is, the first data transmission). A DL ACK 508 may be transmitted from the TRP 102 to the UE 114 after a DL/UL switch gap 510 from the ending time of the UL data set 506. In this example, the UE 114 receives updated one or more transmission parameters from TRP 102 and maintains itself in the sleep state after the first data transmission 404.

The preamble 502 may be used for UL timing synchronization, UE identification, initial channel estimation and/or acquisition, position measurements or updates, sensing measurements or updates, and/or the like, which, in some embodiments, is also used as a WUS to wake up the TRP 102. Alternatively, a WUS for waking up the TRP 102 may be used as the preamble 502.

In some embodiments, the power control in transmitting the preamble 502 may be semi-statically configured according to a long-term path loss such as the UE's long-term path loss (such as the system information block (SIB), RRC, or the like), or may be configured or otherwise determined by the UE 114.

The AGC head 504 is optional, meaning that, in some embodiments, the UL data burst 500A comprises the AGC head 504 for the TRP 102 to adjust dynamical range of the received power, or in some other embodiments, the UL data burst 500A does not comprise any AGC head 504.

Similar to the DL data field 446, in some embodiments, a UL data field 506 (such as the first UL data field 506-1 or the second UL data field 506-2) may comprise one or more data symbols and one or more RS symbols (wherein the RS symbols may be any suitable RS such as DMRS, SRS, and/or the like), and may further comprise one or more DCI subfields. Moreover, the one or more RS symbols may be in any suitable locations in the UL data field 506 such as in dedicated symbol locations or multiplexed with the data symbols in a same OFDM symbol or DFT-s-OFDM symbol.

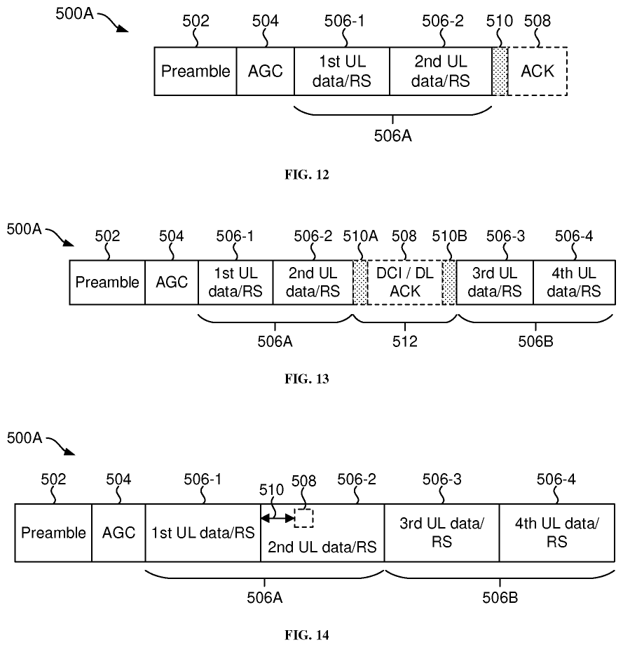

FIG. 13 shows the structure of the UL data burst 500A for transmitting from the UE 114 to the TRP 102 in the fast wakeup and data transmission method 400B, according to some embodiments of this disclosure. As shown, the UL data burst 500A comprises a plurality of fields such as a preamble 502 comprising a fast-wakeup signal to wake up the TRP 102, an optional AGC head 504, and a set of one or more UL data fields 506. The preamble 502 and the optional AGC head 504 are transmitted at step 402 shown in FIG. 11. The one or more UL data fields 506 include, for example, a first UL data set 506A (including one or more UL data fields such as UL data fields 506-1 and 506-2) transmitted at step 404 (that is, the first data transmission), and a second UL data set 506B (including one or more UL data fields such as UL data fields 506-3 and 506-4) transmitted at step 410 (that is, the second data transmission).

The first UL data set 506A and the second UL data set 506B are separated in time by a time period 512 for the TRP 102 to transmit a DL feedback 508 (which may be a DCI and DL ACK) to the UE 114. A DL/UL switch gap 510 may be maintained between neighboring data-burst portion and the UCI/UL data 462, such as a DL/UL switch gap 510A between the first UL data set 506A and the DCI/DL ACK 508, and a DL/UL switch gap 510B between the DCI/DL ACK 508 and the second UL data set 506B, for reducing or eliminating interference. The DL/UL switch gaps 510 may be configured based on for example the switching time required by device, propagation delay, and/or the like.

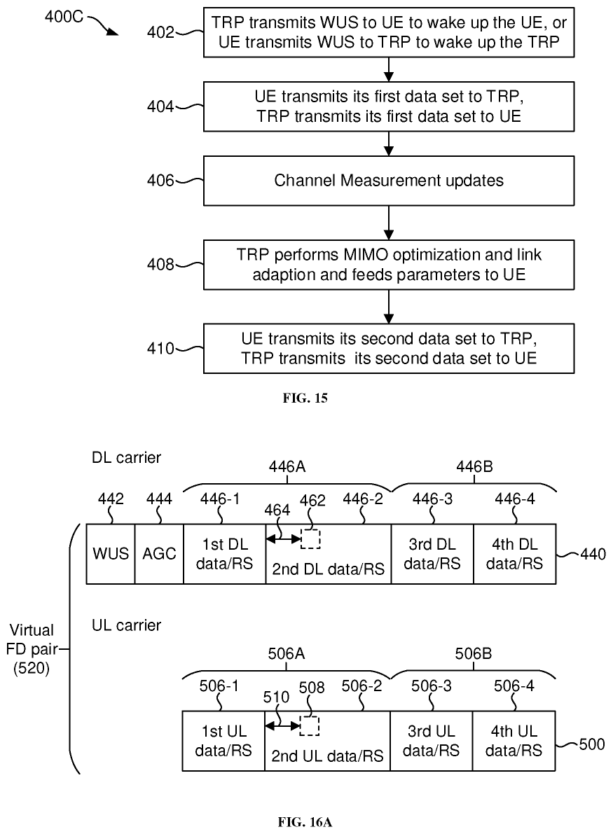

FIG. 14 shows the structure of the UL data burst 500A for transmitting from the UE 114 to the TRP 102 in the fast wakeup and data transmission method 400B, according to some embodiments of this disclosure. As shown, the UL data burst 500A comprises a plurality of fields such as a preamble 502 comprising a fast-wakeup signal to wake up the TRP 102, an optional AGC head 504, and one or more UL data fields 506. The preamble 502 and the optional AGC head 504 are transmitted at step 402 shown in FIG. 11. The one or more UL data fields 506 include, for example, a first UL data set 506A (including one or more UL data fields such as UL data fields 506-1 and 506-2) transmitted at step 404 (that is, the first data transmission), and a second UL data set 506B (including one or more UL data fields such as UL data fields 506-3 and 506-4) transmitted at step 410 (that is, the second data transmission).

A DCI and DL ACK 508 (similar to the DCI and DL ACK 508 shown in FIG. 12) may be transmitted from the TRP 102 to the UE 114 within the time duration of the first UL data set 506A (such as within the time duration of the second UL data field 506-2 after a delay 510 from the starting time of the second UL data field 506-2), and may occupy a portion of the bandwidth (as shown in FIG. 14) or the entire bandwidth. The DL/UL switch gap 510 may be configured by RRC and may be updated by DCI.

FIG. 15 is a flowchart showing the steps of a fast wakeup and data transmission method 400C performed by a TRP 102 and a UE 114 to wake up the TRP 102 and the UE 114 in the sleep state 344, and transmit one or more UL data sets from the UE 114 to the TRP 102 (that is, UL data transmission) and one or more DL data sets from the TRP 102 to the UE 114 (that is, DL data transmission) before the TRP 102 and the UE 114 transitions to the connected state 342, according to some embodiments of this disclosure. In these embodiments, the TRP 102 may use a DL carrier to send a DL data burst 440 (such as any of above-described DL data burst 440A or 440B) to the UE 114, and substantially at the same time, the UE 114 may use a UL carrier to send a UL data burst 500 (such as any of above-described DL data burst 500A or 500B) to the TRP 102, thereby achieving full-duplex (FD) or subband-FD fast-wakeup and data-transmission. The DL data burst 440 and the UL data burst 500 thus form a virtual FD pair 520.

The fast wakeup and data transmission method 400C is substantially a combination of the fast wakeup and data transmission methods 400A and 400B shown in FIGS. 8 and 11. More specifically, step 402 corresponds to that of the fast wakeup and data transmission method 400A shown in FIG. 8 and the corresponding step of the fast wakeup and data transmission method 400B, and each of steps 404 and 410 is the combination of, for example, the corresponding step of the fast wakeup and data transmission method 400A shown in FIG. 8 and the corresponding step of the fast wakeup and data transmission method 400B shown in FIG. 11. Steps 406 and 408 of the fast wakeup and data transmission method 400C may be performed by the TRP 102, the UE 114, or both.

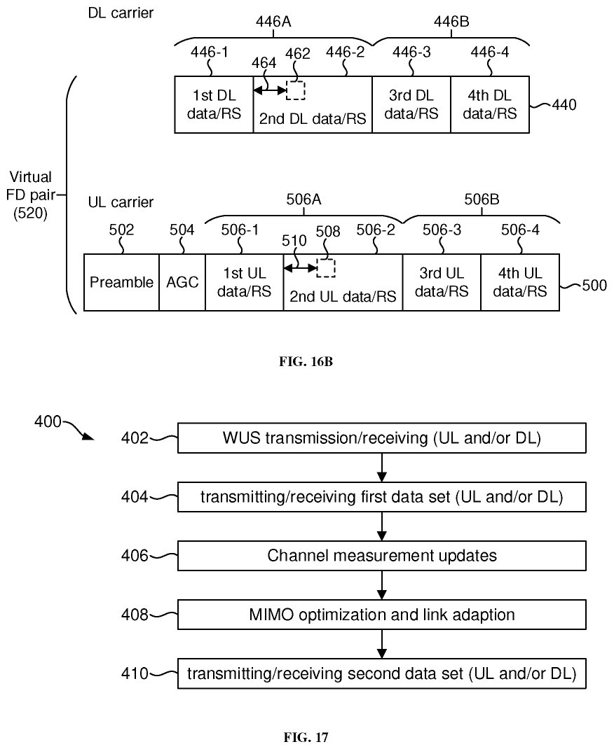

The structures of the UL and DL data bursts in these embodiments are shown in FIGS. 16A and 16B. The difference is that in FIG. 16A, the TRP 102 sends a fast-wakeup signal 442 to the UE 114 via a DL carrier while in FIG. 16B, the UE 114 sends a wakeup preamble 502 to the TRP 102.

In some embodiments similar to that shown in FIG. 8, the UE 114 may send a wakeup preamble to the TRP 102 and then the TRP 102 sends one or more data fields 446 to the UE 114 in a similar manner as described above.

In some embodiments similar to that shown in FIG. 11, the TRP 102 may send a fast-wakeup signal to the UE 114 and then the UE 114 sends one or more data fields 446 to the TRP 102 in a similar manner as described above.

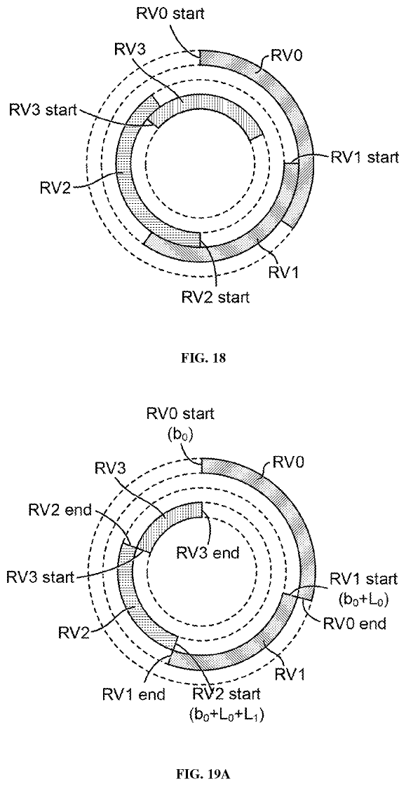

As shown in FIG. 17, the fast wakeup and data transmission methods 400A to 400C may be generalized as a fast wakeup and data transmission method 400 comprises the following steps:
Fast-wakeup signal transmission and receiving (step 402), which may be DL transmission (from a TRP 102 to a UE 114) or UL transmission (from a UE 114 to a TRP 102);
First data transmission and receiving (step 404), which may be DL transmission (from a TRP 102 to a UE 114) or UL transmission (from a UE 114 to a TRP 102);
Channel measurement updates, MIMO optimization, and link adaption (steps 406 and 408);
Second data transmission and receiving using one or more updated communication parameters (step 410), wherein the transmission direction may be the same as or different to that of the first data transmission.

The fast wakeup and data transmission method disclosed herein gives rise to power savings by simplifying the steps to resume connection. The fast wakeup and data transmission method disclosed herein has the following technical features:
One-shot data burst structure;
Single step wakeup;
Wake up & go mechanism;
New initial MCS determination mechanism; and
Progressive precoding/BF adaption and link adaption.

More specifically, the fast wakeup and data transmission method disclosed herein has the following technical features in various embodiments:
A self-contained data burst structure that is simplified from that is used in conventional wakeup methods (such as in existing standards):

By using the self-contained data burst structure, the fast wakeup and data transmission method goes through a process of wake up→data transmission→measurement update→MIMO optimization and link adaptation. The self-contained data burst structure also comprises self-contained multi-purpose RS for channel estimation, channel acquisition, phase noise compensation, time and frequency synchronization, and/or the like.
A fast paging/wakeup signal that reduces the steps of conventional wakeup methods, or combines several steps of conventional wakeup methods:

The fast paging/wakeup signal may comprise two-stage paging/WUS, wherein the first-stage signal is for wakeup and the second-stage signal is for the first data burst scheduling. The fast paging/wakeup signal may carry the timing indication, and may carry one or more initial transmission parameters such as MCS, QCLed beamforming, one or more QoS-related parameters such as latency, one or more reliability requirements, and/or the like. The fast paging/wakeup signal may provide different wakeup time budget depending on sleeping length.
One-shot data transmission that includes various UE behaviors and signaling design such as:
immediate communication after wakeup (with fewer signaling exchanges) to achieve “arrive and go” with no state transitions, and grant-free (GF) first UL data transmission and grant-based (GB) subsequent data transmission (such as the second data transmission).
One-shot data transmission based on information from paging and/or local communication-parameter map which provides, for example, initial BF/MIMO configuration and initial MCS.
CSI update for BF/MIMIO optimization for subsequent data transmission in the same data burst based on feedback of the first received data/reference signal (for example, based on DMRS or based on decoded data).
BF/MIMO optimization based on channel measurement feedback for adjusting MCS based on channel measurement feedback for subsequent data transmission in the same data burst, and for rateless coding based HARQ to approach optimal MCS.

### Link Adaptation:

With link adaption, the initial MCS may be selected based on long-term channel estimation that is obtained from, for example, the communication-parameter map or previous channel measurement results. In the initial MCS selection, only a subset of low modulation levels (for example, QPSK or 16 QAM) may be selected due to the possible imperfect time synchronization, channel quality estimation, and beam management. The initial transmission code rate does not have the same limitation as the modulation order. As such, the code rate and modulation order may not be in the same record (such as the same row) of the MCS table, as is done in existing standards. Rateless codes (for example, low-density parity check (LDPC) codes or polar codes) based flexible-rate code (with fixed payload size K) for a wide range of code rates (between a minimum code rate Rmin and a maximum code rate Rmax) may be used for coding rate adaptation. A transmitter may send N₁ bits first and N₂ bits subsequently. The receiver may opportunistically decode the M bits first, and then jointly decode the N₁+N₂ bits if the first decoding attempt of the N₁ bits fails. The advantage of rateless coding is that it can automatically adapt to channel capacity.

Herein, a rateless code is a code that can encode K information bits to Nmax code bits, where a subset of Mₛ (Mₛ<Nmax) code bits is also a codeword that can be decoded by a decoder. The subset can be obtained in a nested manner. For example, an M₁-subset is always a subset of an M₂-subset if M₁<M₂. A rateless code may be also called a “nested flexible-length code”.

With link adaption, the MCS for subsequent data transmission may be adjusted based on the newly obtained channel measurement information or previous available information or more accuracy sensing results, based on enhanced MIMO scale or BF accuracy, and optionally based on soft ACK/NACK which carries decoding quality information or quantized channel measurement information.
Low power paging/wakeup signals which may be information-carried chirp signals.

### Fast Feedback:

One data burst or data set may contain at least one DL/UL or UL/DL switch gap. The fast wakeup and data transmission method disclosed herein may provide full duplex, subband full duplex, or multi-carrier based virtual full duplex transmission to enable fast feedback without introducing frequent switch between DL and UL.
LCM signal (keep alive information) for tracking UE location, maintaining basic synchronization, and/or the like. The LCM signal may be based on separated low power Tx/Rx, and with configurable monitoring period.
Wakeup signal monitoring, which may be configured before UE goes to the sleep state.
   D-2. Fast Wakeup and Data Transmission Methods with Progressive Self-Link Adaptation

Embodiments described in the follows focus on the link adaptation methods for the above-mentioned fast wakeup and data transmission methods, for self-contained data burst transmission that may not be able to obtain an accurate channel estimation due to the stringent time budget that may be insufficient for pilot transmission.

In conventional methods, accurate channel estimation may be obtained and near-optimal MCS selection is performed to choose from a pre-defined set of target code rate and modulation, in which a transmitter expects the receiver to successfully decode with high probability (for example, 0.9 or higher). Therefore, a code rate and a modulation order are matched to provide good performance. Each record (such as each row) of the MCS table indicates both a code rate and a modulation order, whereas a low code rate is associated with a small modulation order.

In the following embodiments, the fast wakeup and data transmission method may perform the first data transmission based on inaccurate channel estimation, wherein the MCS selection is for flexible target code rate and modulation, in which a transmitter (such as a TRP 102 or a UE 114 transmitting data) only expects the receiver (such as a corresponding UE 114 or a TRP 102 receiving the transmitted data) to decode with best effort. Rateless codes (either LDPC codes or polar codes) have the advantage of constructing a flexible-rate code (with fixed payload size K) for a wide range of code rates (between a minimum code rate Rmin and a maximum code rate Rmax), which provides a good property of being near-optimal at all code rates within that range, and enables the receiver to decode at any rate below channel capacity. Therefore, a transmitter can send N₁ bits first and N₂ bits subsequently. The receiver may opportunistically decode the N₁ bits first, and then jointly decode the M₁+N₂ bits if the first attempt fails.

The methods disclosed herein can be implemented in next-generation mobile and wireless network service, cloud and edge computing service, and sensing services. The method may be particularly useful for devices with power-saving considerations, such as battery-powered mobile phones, tablets, sensors, IoT devices, and/or the like.

In some embodiments, the fast wakeup and data transmission method uses a rateless coding based HARQ to approach optimal MCS and transmit at least some of the data-bearing and/or control information bearing fields.

When HARQ is used, the data bits to be transmitted are encoded using a forward error correction (FEC) method such as LDPC. The encoded bits are then punctured or rate-matched such that a subset of the encoded bits are selected for transmission or retransmission. The RV determines which encoded bits are selected for transmission/retransmission. Different RVs give rise to different subsets of encoded bits selected for transmission/retransmission.

For example, FIG. 18 shows the conventional RVs. As shown, the data bits to be transmitted are encoded using LDPC. The encoded bits are stored in a circular buffer. Each of the RVs, RV0 to RV3 indicates a subset of the encoded bits starting from a predefined bit location.

When HARQ is used, the transmitter first selects a RV, such as RV0, for transmission.

If the receiver successfully receives and decodes the received data (that is, RV0), the receiver sends an ACK to the transmitter and no retransmission is required.

If the receiver cannot decode RV0, the receiver stores RV0 and sends a negative-acknowledgement (NACK) to the transmitter. The transmitter then selects another RV, such as RV1, for retransmission. The receiver receives RV1 and tries to decode the combination of RV0 and RV1 (represented as RV0+RV1). If the receiver successfully decodes RV0+RV1, the receiver sends an ACK to the transmitter and no retransmission is required.

If the receiver cannot decode RV0+RV1, the receiver also stores RV1 and sends a NACK to the transmitter. The transmitter then selects another RV, such as RV3, for retransmission. The receiver receives RV3 and tries to decode the combination of RV0+RV1+RV3. If the receiver successfully decodes RV0+RV1+RV3, the receiver sends an ACK to the transmitter and no retransmission is required.

Such a procedure repeats until all RVs are sent to the receiver.

In various embodiments, the data-bearing and/or control information bearing data may refer to the fast wakeup signal 442, the first DL data set 446A (such as the first and second DL data fields 446-1 and 446-2), the second DL data set 446B, the fast-wakeup preamble 502, the first UL data set 506A (such as the first and second UL data fields 506-1 and 506-2), and/or the second UL data set 506B.

As described above, the fast-wakeup signal 442 may be a control information bearing signal. For example, in some embodiments, the fast-wakeup signal 442 is in a simplified DCI format (for example, with less fields or bits compared to DCI of regular scheduling, which may be feasible because the fast-wakeup signal 442 is used to schedule initial transmission with estimated channel condition and because of reduced transmission capabilities such as MIMO, bandwidth, MCS, and/or the like).

The fast-wakeup signal 442 may be a two-stage fast-wakeup signal including a first-stage WUS such as a first-stage paging signal for waking up the receiving device (such as the UE 114) and a second-stage WUS such as a second-stage paging signal for scheduling the transmission of the first DL data set 446A.

More specifically, the second-stage WUS may comprise the indication of time-frequency resource (such as DCI, including the total number of one or more slots and/or the indices of one or more slots, bandwidth, carrier index or indication, and/or the like) for each of the one or more DL data fields of the first DL data set 446A, the initial BF and/or MIMO information, initial MCS, HARQ, and/or the like for the one or more DL data fields. Optionally, the second-stage WUS may also comprise indication of positioning reference signal (PRS), CSI-RS, and/or other measurement-reference signal configurations. Optionally, the second-stage WUS may further comprise an absolute timing reference.

The use of the two-stage fast-wakeup signal may further reduce wakeup signal detection power consumption because the second-stage WUS may only be performed once the first-stage WUS is successfully detected. Since the first-stage WUS does not contain control information, it may simply be, for example, a sequence or other types of signatures. Of course, in some embodiments, the fast-wakeup signal 442 may be a single-stage WUS containing, for example, control information and the UE ID.

Similarly, the fast-wakeup preamble 502 may also contain control information for the first UL data set 506A.

Using the fast-wakeup signal 442 or fast-wakeup preamble 502 (both denoted as the “fast-wakeup signal” for ease of description) as an example, the fast wakeup and data transmission method uses HARQ with rateless coding (such as LDPC codes or polar codes) and flexible RVs for encoding and transmitting at least the control information bearing portion of the fast-wakeup signal (such as the second-stage WUS if the fast-wakeup signal is a two-stage fast-wakeup signal), wherein a plurality of flexible RVs of the rateless coded fast-wakeup signal are used for transmission and, if needed, one or more retransmissions.

Those skilled in the art will appreciate that, any suitable rateless coding methods may be used for encoding the wakeup signal.

For example, in some embodiments wherein the wakeup signal is very short (for example, shorter than a first length-threshold such as 10 bits), the wakeup signal may not be encoded using a rateless coding method. Rather, it may be digitally modulated using a suitable method such as Manchester code or on-off keying (OOK). Of course, in some other embodiments, the Manchester code or OOK of the very short wakeup signal may be encoded using a rateless coding method.

In some embodiments wherein the wakeup signal is short (for example, shorter than a second length-threshold (such as 1000 bits) but longer than the first length-threshold), polar code may be used for encoding the wakeup signal.

In some embodiments wherein the wakeup signal is long (for example, longer than the second length-threshold, which may occur when, for example, the wakeup signal is jointly encoded with the first data set; described in more detail below), LDPC code may be used for encoding the wakeup signal (or more specifically, for jointly encoding the wakeup signal and the first data set).

After encoding, a plurality of RVs are defined in the encoded bits. In other words, each of the plurality of RVs comprises a different subset of the encoded bits. As described above, a first RV may be transmitted, and then subsequent RVs may be transmitted if the previously transmitted RVs are not successfully decoded.

In these embodiments, each flexible RV has a flexible or variable length (that is, not a predefined length), and/or is preferably self-decodable. Herein, the term “self-decodable” means that a decoder may decode a RV without relying on another RV (such as a previously received RV). The length of a flexible RV may vary in accordance with the rateless coding method used, and is determined before the flexible RV is transmitted based on the available time and frequency resource.

In other words, the plurality of flexible RVs comprises a first group of one or more RVs for the initial transmission and, if the first group comprises multiple RVs, the first one or more retransmissions of the wakeup signal, and a second group of one or more RVs for subsequent retransmission. The first group of RVs are preferably more robust and more self-decodable compared to the second group of RVs. For example, if LDPC codes are used, each of the first group of RVs may comprise at least some systematic bits regardless the length of the RV, while the second group of RVs do not have this requirement.

As shown in FIG. 19A, in these embodiments, the starting bit location of the first transmitted RV (such as RV0) may be predefined or randomly selected (for example, starting from the bₒ-th encoded bit). Each subsequently transmitted RV starts from the immediately next bit location of the end location of the previously transmitted RV. For example, the second transmitted RV such as RV1 starts from the (bₒ+Lₒ)-th encoded bit (where Lₒ is the length of RV0); the third transmitted RV such as RV2 starts from the (bₒ+Lₒ+Lₜ)-th encoded bit; and so on so forth. Those skilled in the art will appreciate that the total length of the transmitted RVs may equal to the length of the encoded bits (as shown in FIG. 19A), may be shorter than the length of the encoded bits (meaning that some encoded bits are not transmitted), or may be greater than the length of the encoded bits (meaning that some encoded bits are transmitted more than once).

Due to the very short gap between consecutive transmissions, the consecutively transmitted/retransmitted RVs may also be considered or treated as if they are different parts of a same RV (which are separately transmitted). For example, the consecutively transmitted RV0 and RV1 in FIG. 19A may be considered as two portions RV0-1 and RV0-2 of the same RV0 in FIG. 19B. The consecutively transmitted RV2 and RV3 in FIG. 19A may be considered as two portions RV1-1 and RV1-2 of the same RV1 in FIG. 19B.

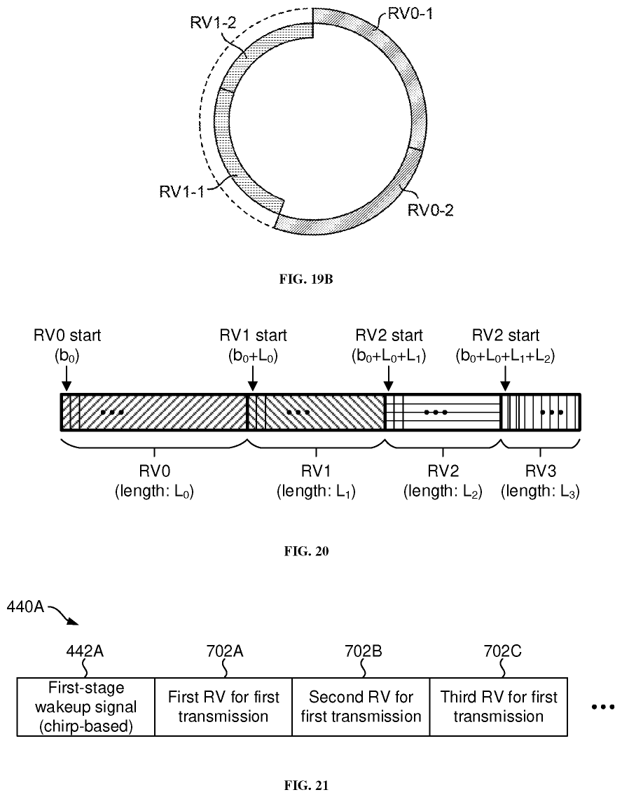

In some embodiments, the encoded bits may not need to be put in a circular buffer. Rather, the encoded bits may be arranged in a linear manner as shown in FIG. 20. A plurality of RVs (such as RV0, RV1, RV2, and RV3) may be defined as described above, wherein the first RV, RV0, starts from the first encoded bit, each subsequently transmitted RV starts from the immediately next bit location of the end location of the previously transmitted RV, and the last RV, RV3, ends before or at the last encoded bit. In other words, the summation of the lengths of the plurality of RVs is less than or equal to the length of the encoded bits, for example, Lₒ+L₁+L ₂+L₃≤L_{E}, where Lₒ, L₁, L₂, and L₃ are the lengths of RV0, RV1, RV2, and RV3, respectively, and L_{E} is the length of the encoded bits.

In some embodiments, not all RVs have to start from the immediately next bit location of the end location of the previously transmitted RV, and a subset of consecutive RVs may overlap (that is, a subsequently transmitted RV may start from before the end location of the previously transmitted RV) in a manner similar to the conventional RVs as shown in FIG. 18.

Other data-bearing and/or control information bearing fields may be encoded and transmitted in a similar manner.

Thus, for a data-bearing or control information bearing field, a transmitter such as a TRP 102 may transmit a RV thereof to a receiver such as a UE 114. The UE 114 receives the RV and feeds back a soft ACK/NACK to the transmitter based on the decoding result. The TRP 102 then decides whether another RV of the same field needs to be transmitted, or proceed with the transmission of the next field.

In some embodiments, the RVs may also comprise one or more pilot symbols and/or subcarriers which may be used by the UE 114 for updating channel measurements for feeding back to the TRP via the soft ACK/NACK. The TRP 102 may refine the MCS for subsequent transmission based on the newly obtained channel measurement information.

In some embodiments, the decoding of a transmitted RV may be exploited to obtain more accurate channel estimation results. For example, the MCS for the subsequent RV may be obtained based on soft ACK/NACK information fed back to the transmitter, which contains decoding quality information of the transmitted RV, or quantized channel measurement information.

In some embodiments, each data-bearing and/or control information bearing field may be separately encoded, or jointly encoded. For example, the fast-wakeup signal and the first data set may be concatenated as one block for rateless encoding as described above.

In some embodiments, the fast wakeup and data transmission method uses a rateless code (such as a polar code or a LDPC code) with a plurality of flexible RVs to transmit at least some of the data-bearing and/or control information bearing fields.

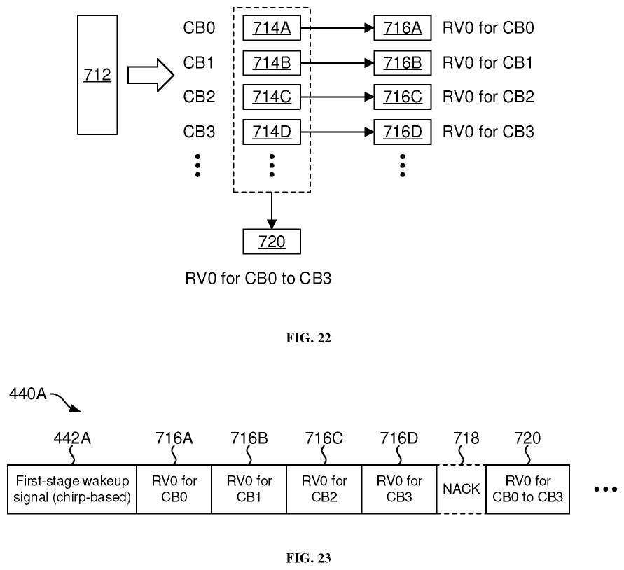

For example, FIG. 21 shows a portion of a DL data burst 440A. In these embodiments, the fast wakeup signal 442 comprises a first-stage chirp-based wakeup signal 442A and a second-stage wakeup signal. The second-stage wakeup signal and the first DL data set are jointly encoded using LDPC (such as LDPC defined in 5G NR) with a plurality of RVs defined therefor as described above.

Instead of transmitting one RV and waiting for ACK or NACK to decide on whether a subsequent RV should be transmitted, the TRP 102 transmits a plurality of RVs 702A and 702B (and optionally 702C) of the combination of the second-stage wakeup signal and the first DL data set as part of the DL data burst 440A. The first RV 702A immediately follows the first-stage wakeup signal 442A, and both belongs to the self-contained transmission. The second RV 702B and optionally the third RV 702C are also transmitted subsequently, which is helpful because there may be a high probability that the decoding of first RV 702A at the UE side would fail.

The UE 114 receives the RVs 702A to 702C and feeds back a soft ACK/NACK to the transmitter based on the joint decoding result of the received RVs 702A to 702C. The TRP 102 then decides whether another RV of the same field needs to be transmitted, or proceed with the transmission of the next field.

In some embodiments, at least one of the RVs 702A to 702C may also comprise pilot symbols and/or subcarriers which may be used by the UE 114 for updating channel measurements for feeding back to the TRP via the soft ACK/NACK. The TRP 102 may refine the MCS for subsequent transmission based on the newly obtained channel measurement information.

In some embodiments, the decoding of the RVs 702A to 702C may be exploited to obtain more accurate channel estimation results. For example, the MCS for the subsequent RV may be obtained based on soft ACK/NACK information fed back to the transmitter, which contains decoding quality information of the RVs 702A to 702C, or quantized channel measurement information.

Since the first transmission may suffer from severe signal distortion, which may be detrimental to the soft combining decoding with subsequent transmissions, the first and second transmitted RVs (for example, RVs 702A and 702B shown in FIG. 21) may be self-decodable RVs. For example, in 5G NR LDPC, the two self-decodable RVs with RV IDs of 0 and 2 may be used for first and second RV transmissions. RVs in subsequent transmissions may not need to be self-decodable.

In some embodiments, a cross code-blocks (CB) outer coding may be further applied to the ratelessly encoded blocks to generate multiple RVs having different parity CBs. The coding gain results from the larger overall code length through coupling multiple CBs.

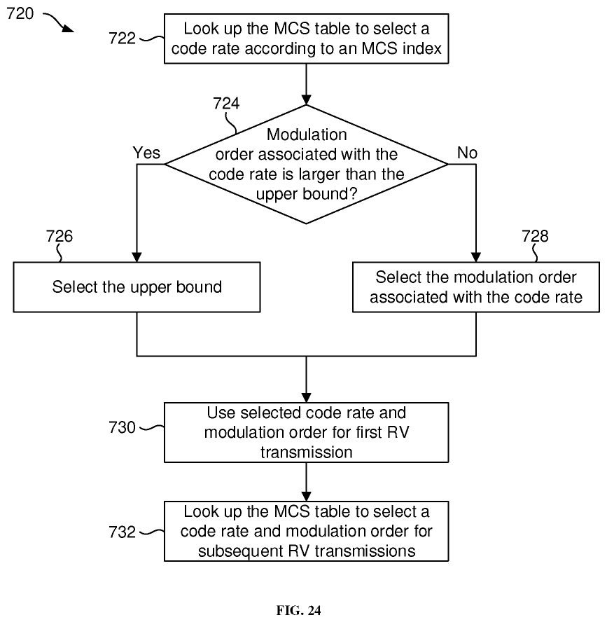

More specifically, as shown in FIG. 22, a large-size data-bearing and/or control information bearing field 712 may be partitioned into a plurality of CBs 714. Each CB 714 is encoded using the rateless coding method for obtaining a plurality of RVs 716. Each RV 716 has its own parity.

The TRP 102 may each time transmit the RVs 716 for at least a subset of the CBs 714, and retransmit a cross-CB RV for the at least subset of the CBs 714 if a NACK is received from the UE 114

For example, as shown in FIG. 23, in the first transmission, the TRP 102 transmits a plurality of RVs 716A to 716D each for a respective CB 714A to 714D of the data-bearing and/or control information bearing field 712. Then, if the TRP 102 receives a NACK 718 from the UE 114, the TRP 102 generates a cross-CB RV 720 for the combination of CBs 714A to 714D, and retransmits the cross-CB RV 720 in the second transmission (that is, the first retransmission).

In above description, DL data burst 440A is used as an example. Those skilled in the art will appreciate that the same rateless coding method may also be used for DL data burst 440B, UL data burst 500A, and/or UL data burst 500B.

In some embodiments, the fast wakeup and data transmission method may use progressive link adaptation for approaching optimal MCS. In these embodiments, the fast wakeup and data transmission method may first perform initial MCS selection based on long term channel estimation for the first transmission of the data-bearing and control information bearing fields (such as the second-stage wakeup signal), and then progressively adjust MCS in subsequent transmissions of the data-bearing and control information bearing fields.

In the initial MCS selection, the transmitter (such as the TRP 102 or UE 114) may exploit history channel statistics or measurements (for example, obtained or based on the communication-parameter map). However, these measurements may be outdated and inaccurate, and there may exist other issues such as possible imperfect time synchronization, channel quality estimation, and beam management.

In some embodiments, the fast wakeup and data transmission method may use a long-term MCS with lower maximum modulation order for transmission of the data-bearing and control information bearing fields when at least one of the TRP 102 and UE 114 is in the sleep state.

More specifically, in these embodiments, a long-term MCS may be separately defined for the determination of coding rate and modulation order for the first transmission of the data-bearing and control information bearing fields for the following reasons:

Due to the opportunistic nature of the initial transmission, a higher-than-usual code rate can be selected. If the channel condition is good and channel estimation is accurate, the transmission can be successfully decoded. In case the initial decoding fails, the subsequent transmissions may be used for soft combining.

Due to the inaccurate channel estimation and thus the distorted signal, a lower-than-normal modulation order can be selected to better distinguish between the different symbols in the QAM constellation. Moreover, the low modulation order also considers subsequent transmissions that can make the effective code rate lower.

Comparing to the conventional MCS tables (which may be used in the connected state), each row of the long-term MCS table comprises a lower-than-usual modulation order and a higher-than-usual code rate.

More specifically, the long-term MCS table only comprises low modulation orders such as 1, 2, and/or 4 (that is, binary phase shift keying (BPSK), quadrature phase shift keying (QPSK) and/or 16-constellation quadrature amplitude modulation (16 QAM)). Each modulation order in the long-term MCS table corresponds to one or more channel code rates. For each modulation order, the minimum channel coding rate corresponding thereto is higher than the minimum channel coding rate corresponding to the same modulation order in the MCS tables used in the connected state (such as conventional MCS tables).

For example, Table 1 shows an example of a long-term MCS table. The maximum modulation order in the table is 4 or 16 QAM. The minimum channel coding rate for modulation order 2 is 340 (that is 340/1024=0.33) which is higher than the minimum channel coding rate of 120 or 30 for modulation order 2 in conventional MCS tables used in 5G NR. The minimum channel coding rate for modulation order 4 is 567 (that is 567/1024=0.55) which is higher than the minimum channel coding rate of 340 or 378 for modulation order 4 in conventional MCS tables used in 5G NR.

TABLE 1
Example of long-term MCS table

| MCS | Modulation | Target code | |
|---|---|---|---|
| Index | Order | Rate × [1024] | Spectral |
| I_{MCS} | Qₘ | R | efficiency |
| 0 | 2 | 340 | 0.6644 |
| 1 | 2 | 378 | 0.7386 |
| 2 | 2 | 434 | 0.8480 |
| 3 | 2 | 490 | 0.9575 |
| 4 | 2 | 553 | 1.0806 |
| 5 | 2 | 616 | 1.2037 |
| 6 | 2 | 658 | 1.2857 |
| 7 | 2 | 438 | 0.8559 |
| 8 | 2 | 466 | 0.9106 |
| 9 | 2 | 517 | 1.0102 |
| 10 | 4 | 567 | 2.2158 |
| 11 | 4 | 616 | 2.4073 |
| 12 | 4 | 666 | 2.6027 |
| 13 | 4 | 719 | 2.8099 |
| 14 | 4 | 772 | 3.0170 |
| 15 | 4 | 822 | 3.2124 |

In some embodiments, the fast wakeup and data transmission method may use a MCS table that is designed for use when both the TRP 102 and UE 114 are in the connected state (denoted “connected-state MCS table”; such as a conventional MCS table) for transmission when at least one of the TRP 102 and UE 114 is in the sleep state, for example, for the first transmission of the data-bearing and control information bearing fields. In these embodiments, the fast wakeup and data transmission method uses different or additional methods (comparing to the conventional methods) for determining the coding rate and modulation order for the first transmission of the data-bearing and control information bearing fields.

More specifically, when using a connected-state MCS table for the first transmission of the data-bearing and control information bearing fields, the fast wakeup and data transmission method applies an upper bound (for example, less than or equal to 4) on the modulation order that can be selected for the purpose of robust demodulation. Such an upper bound is much smaller than the maximum modulation order (for example, 10 (that is, 1024 QAM)) in the connected-state MCS table.

On the other hand, since the transmitter does not entirely rely upon the successful decoding in the first transmission, the initial channel code rate does not have to be limited to the channel code rate corresponding to the selected modulation order in the connected-state MCS table, and a higher channel code rate may be selected. For example, in some embodiments, the initial channel code rate may be determined by the estimated CQI. As such, the selected code rate and modulation order may not be in the same row of the connected-state MCS table.

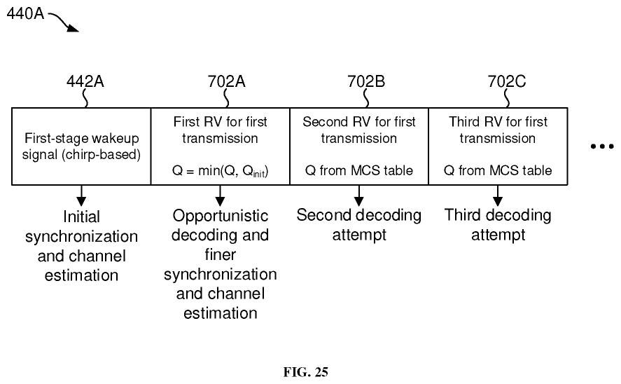

FIG. 24 is a flowchart showing the steps of the fast wakeup and data transmission method for selecting the code rate and modulation order from a connected-state MCS table for the first transmission of the data-bearing and control information bearing fields. FIG. 25 shows an example of signal transmission using the fast wakeup and data transmission method shown in FIG. 24.

Step 722 is performed after the first-stage wakeup signal 442A is transmitted. At step 722, the transmitter looks up the connected-state MCS table using a MCS index to select a channel code rate. The MCS index may be a predefined MCS index for the first transmission or a MCS index according to estimated channel (for example, according to the CSI).

At step 724, if the modulation order associated with the selected channel code rate in the connected-state MCS table is larger or greater than the upper bound (the “Yes” branch of step 724), the upper bound is selected as the modulation order (step 726).

If the modulation order associated with the selected channel code rate in the connected-state MCS table is not larger than the upper bound (the “No” branch of step 724), the modulation order associated with the selected channel code rate in the connected-state MCS table is selected as the modulation order (step 728).

At step 730, the selected channel code rate and modulation order are used for the first RV for the first transmission (702A in FIG. 23).

As described above, the decoding of the first RV at the receiver side may be opportunistic decoding with high probability of failure. However, the receiver may use the first RV to refine synchronization and channel estimation, and provide channel measurement feedback via soft ACK/NACK.

After the first RV transmission, the transmitter may receive channel measurement feedback from the receiver via the soft ACK/NACK. Accordingly, the subsequent RV transmissions such as the second and third RV transmissions 702B and 702C in FIG. 23 (if the previous RV transmission fails) may use the connected-state MCS table in the same manner as in conventional methods, so as to allow the overall transmissions to gradually approach the optimal MCS.

In above embodiments, various embodiments of the fast wakeup and data transmission method with progressive self-link adaptation are disclosed, wherein the fast wakeup and data transmission method may comprise some or all of the following features:
Rateless coding based on coarse initial channel estimation
   Adjusting MCS based on channel measurement feedback for subsequent data transmission in the same data burst.
   Rateless coding based HARQ to approach optimal MCS based on channel measurement feedback.
Link adaptation
   Initial MCS selection based on long term channel estimation.
   Subsequent data transmission MCS may be adjusted.

The fast wakeup and data transmission method with progressive self-link adaptation disclosed herein may provide various advantages such as:
Low energy consumption
   Lengthy wakeup procedures and state transitions in conventional methods are reduced.
Improved spectrum efficiency and lowered latency
   Initial transmission may be fast and may be successfully decoded if the one or more initial channel parameters are accurate.
   If the one or more initial channel parameters are inaccurate, the received signals can still be exploited for soft combining with the subsequent received signals.
   The spectrum usage is efficient.

As those skilled in the art will appreciate, state transition usually requires certain overhead. Therefore, in some embodiments, the TRP 102 and/or UE 114 does not transition between different states. Rather, the TRP 102 and/or UE 114 may perform the fast wakeup and data transmission methods disclosed herein when at least one of the TRP 102 and/or UE 114 is in restricted or reduced power consumption for wireless communication related activities (in other words, with a restricted or reduced wireless communication capability). After data transmission/receiving, the device or devices in the same power consumption level or change to increased, less restricted, unrestricted, or even full power consumption for wireless communication related activities (that is, with increased or even full wireless communication capability). While a device in restricted or reduced power consumption for wireless communication related activities may be appear to be similar to the RRC_INACTIVE state and the device, and a device in increased, less restricted, unrestricted, or even full power consumption for wireless communication related activities may appear to be similar to the RRC_CONNECTED state, the “stateless” embodiments disclosed herein is significantly different to the RRC states in that, in the “stateless” embodiments disclosed herein, the devices do not need state transition thereby eliminating the overhead associated therewith.

As those skilled in the art will appreciate, various apparatuses, devices, components, modules, and/or the like in the communication system 100 that perform communication functions may be generally denoted “communication nodes” or simply “nodes”. For example, TRPs 102 and UEs 114 are communication nodes, wherein TRPs 102 may also be denoted “network nodes” or “access nodes” as the TRPs 102 provides or otherwise enables the UE's access to the RANs 102.

The above-described method applies to a wide range of communication networks, such as 5G+, 6G, WI-FI® (WI-FI is a registered trademark of Wi-Fi Alliance, Austin, TX, USA), non-terrestrial networks (NTNs), and distributed or self-organized networks.

### E. Acronyms

| | Acronym/Abbreviation/ |
|---|---|
| Full Name | Initialism |
| Long Term Evolution | LTE |
| New Radio | NR |
| Forward error correction | FEC |
| Multiple Access | MA |
| Quality of Service | QoS |
| low-density parity check codes | LDPC |
| cyclic redundancy check | CRC |
| ultra-reliable low latency | uRLLC |
| communications | |
| Enhanced mobile broadband | eMBB |
| massive Machine Type Communications | mMTC |
| non-terrestrial networks | NTN |
| Internet of Things | IoT |
| Bit Error Rate | BER |
| Block Error Rate | BLER |
| Packet Error Rate | PER |
| Spectral Efficiency | SE |
| Hybrid automatic repeat request | HARQ |
| Channel Quality Indicator | CQI |
| Modulation Coding Scheme | MCS |
| gNodeB or 5G base station | gNB |
| user equipment | UE |
| Radio Resource Control | RRC |
| Radio Network Temporary Identifier | RNTI |
| Uplink Control Information | UCI |
| Downlink Control Information | DCI |
| Physical Broadcast Channel | PBCH |
| Half-radio frame bit | HRF |
| Synchronization Signal Block | SSB |
| unequal error protection | UEP |
| variable node | VN |
| check node | CN |
| Log-likelihood ratio | LLR |

### F. Definitions of Some Terms

Herein, the term “one shot self-contained data transmission” or “one shot data transmission” specifically refers to the simplified process for rapid data transmission including receiving wakeup signal, performing minimum channel measurement, and transmitting/receiving a not-too-large amount of data.

Herein, the term “predefined” (for example, a “predefined” item such as a “predefined” parameter) refers to an item defined before the fast wakeup and data transmission method disclosed herein is performed (for example, defined as a system design parameter such as defined by relevant standards).

Herein, the term “preconfigured” (for example, a “preconfigured” item such as a “preconfigured” parameter) refers to an item configured (for example, by a TRP 102) before a certain even occurs. For example, in some embodiments, a preconfigured item may be configured before the TRP 102 and/or UE 114 enters reduced power consumption or the sleep state. In some embodiments, a preconfigured item may be configured before the wakeup signal or the wakeup preamble is transmitted.

Herein, each of the expression “at least one of A, B, and C” and the expression “at least one of A, B, or C” refers to “A, B, C, or a combination thereof”, or “at least one selected from the group of A, B, and C”.

Herein, various embodiments of the fast wakeup and data transmission methods are described. In various embodiments, the fast wakeup and data transmission methods disclosed herein may be implemented as hardware, software, firmware, or a combination thereof, and may be implemented in any suitable form. Depending on the functionalities of various features of the methods disclosed herein, some features may be implemented on the network side (such as in one or more TRPs), some other features may be implemented on the UE side, and/or yet some other features may be implemented on both the TRP and the UE sides. Depending on the functionalities of various features of the methods disclosed herein, some features may be implemented on the transmitting side (such as in one or more TRPs and/or one or more UEs for transmission), some other features may be implemented on the receiving side (such as in one or more TRPs and/or one or more UEs for receiving), and/or yet some other features may be implemented on both the transmitting and the receiving sides.

For example, in some embodiments, the fast wakeup and data transmission methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the fast wakeup and data transmission methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method applied in a first communication node for wireless communication with a second communication node, at least one of the first communication node or the second communication node being in reduced power consumption for wireless communication related activities, the method comprising:
transmitting to the second communication node at least a first redundancy version of a data piece,
wherein the data piece is at least one of: (i) at least a first portion of a wakeup signal or (ii) a first data set, the at least the first portion of the wakeup signal comprising control information for the first data set,
wherein the first redundancy version is one of a plurality of first candidate redundancy versions, and
wherein each of the plurality of first candidate redundancy versions comprises a different subset of a plurality of first encoded bits, and the plurality of first encoded bits is obtained by encoding the data piece using a first coding method.

2. The method of claim 1, wherein the at least one of the first communication node or the second communication node is in a sleep state during transmission of the wakeup signal and transmission of the first data set.

3. The method of claim 1, wherein the first coding method is a first rateless coding method.

4. The method of claim 1, wherein the wakeup signal comprises the first portion and a second portion, and
wherein the method further comprises:
transmitting to the second communication node the second portion of the wakeup signal.

5. The method of claim 1, wherein the plurality of first candidate redundancy versions comprises at least a pair of consecutive first candidate redundancy versions, and
wherein a starting bit of a first one of the pair of consecutive first candidate redundancy versions is an immediately next bit of an end bit of a second one of the pair of consecutive first candidate redundancy versions.

6. A method applied in a first communication node for wireless communication with a second communication node, at least one of the first communication node or the second communication node being in reduced power consumption for wireless communication related activities, the method comprising:
receiving from the second communication node at least a first redundancy version of a data piece,
wherein the data piece is at least one of: (i) at least one a first portion of a wakeup signal or (ii) a first data set, the at least the first portion of the wakeup signal comprising control information for the first data set,
wherein the first redundancy version is one of a plurality of first candidate redundancy versions, and
wherein each of the plurality of first candidate redundancy versions comprises a different subset of a plurality of first encoded bits, and the plurality of first encoded bits is obtained by encoding the data piece using a first coding method.

7. The method of claim 6, wherein the at least one of the first communication node or the second communication node is in a sleep state during transmission of the wakeup signal and transmission of the first data set.

8. The method of claim 6, wherein the first coding method is a first rateless coding method.

9. The method of claim 6, wherein the wakeup signal comprises the first portion and a second portion, and
wherein the method further comprises:
receiving from the second communication node the second portion of the wakeup signal.

10. The method of claim 6, wherein the plurality of first candidate redundancy versions comprises at least a pair of consecutive first candidate redundancy versions, and
wherein a starting bit of a first one of the pair of consecutive first candidate redundancy versions is an immediately next bit of an end bit of a second one of the pair of consecutive first candidate redundancy versions.

11. An apparatus in a first communication node for wireless communication with a second communication node, at least one of the first communication node and the second communication node being in reduced power consumption for wireless communication related activities, the apparatus comprising:
at least one processor coupled with at least one memory storing one or more instructions that are capable of being run on the at least one processor, wherein when the one or more instructions are run, the apparatus is enabled to:
transmit to the second communication node at least a first redundancy version of a data piece,
wherein the data piece is at least one of: (i) at least a first portion of a wakeup signal or (ii) a first data set, the at least the first portion of the wakeup signal comprising control information for the first data set,
wherein the first redundancy version is one of a plurality of first candidate redundancy versions, and
wherein each of the plurality of first candidate redundancy versions comprises a different subset of a plurality of first encoded bits, and the plurality of first encoded bits is obtained by encoding the data piece using a first coding method.

12. The apparatus of claim 11, wherein the at least one of the first communication node or the second communication node is in a sleep state during transmission of the wakeup signal and transmission of the first data set.

13. The apparatus of claim 11, wherein the first coding method is a first rateless coding method.

14. The apparatus of claim 11, wherein the wakeup signal comprises the first portion and a second portion, and wherein when the one or more instructions are run, the apparatus is enabled to transmit to the second communication node the second portion of the wakeup signal.

15. The apparatus of claim 11, wherein the plurality of first candidate redundancy versions comprises at least a pair of consecutive first candidate redundancy versions, and
wherein a starting bit of a first one of the pair of consecutive first candidate redundancy versions is an immediately next bit of an end bit of a second one of the pair of consecutive first candidate redundancy versions.

16. An apparatus in a first communication node for wireless communication with a second communication node, at least one of the first communication node or the second communication node being in reduced power consumption for wireless communication related activities, the apparatus comprising:
at least one processor coupled with at least one memory storing one or more instructions that are capable of being run on the at least one processor, wherein, when the one or more instructions are run, the apparatus is enabled to:
receive from the second communication node at least a first redundancy version of a data piece,
wherein the data piece is at least one of: (i) at least a first portion of a wakeup signal or (ii) a first data set, the at least the first portion of the wakeup signal comprising control information for the first data set,
wherein the first redundancy version is one of a plurality of first candidate redundancy versions, and
wherein each of the plurality of first candidate redundancy versions comprises a different subset of a plurality of first encoded bits, and the plurality of first encoded bits is obtained by encoding the data piece using a first coding method.

17. The apparatus of claim 16, wherein the at least one of the first communication node or the second communication node is in a sleep state during transmission of the wakeup signal and transmission of the first data set.

18. The apparatus of claim 16, wherein the first coding method is a first rateless coding method.

19. The apparatus of claim 16, wherein the wakeup signal comprises the first portion and a second portion, and wherein when the one or more instructions are run, the apparatus is enabled to receive from the second communication node the second portion of the wakeup signal.

20. The apparatus of claim 16, wherein the plurality of first candidate redundancy versions comprises at least a pair of consecutive first candidate redundancy versions, and
wherein a starting bit of a first one of the pair of consecutive first candidate redundancy versions is an immediately next bit of an end bit of a second one of the pair of consecutive first candidate redundancy versions.
